(19) United States
(12) Patent Application Publication
(10) Pub. No.: US 2026/0271826 A1
(43) Pub. Date: Sep. 17, 2026

(54) SYSTEM

(71) Applicant: SoftBank Group Corp., Tokyo (JP)

(72) Inventor: Aoi HANEDA, Tokyo (JP)

(73) Assignee: SoftBank Group Corp., Tokyo (JP)

(21) Appl. No.: 19/548,972

(22) Filed: Feb. 25, 2026

Related U.S. Application Data
(60) Provisional application No. 63/770,740, filed on Mar. 12, 2025.

(51) Int. Cl. A01C 21/00; B25J 11/00; B25J 13/00; G06F 40/205; G06F 40/40; G06N 3/0442; G06N 3/0455; G06N 3/0475; G06V 10/44; G06V 10/764; G06V 10/82; G06V 10/94; G06V 20/10; G06V 20/70; G10L 25/63

(52) U.S. Cl. CPC A01C 21/005; B25J 11/00; B25J 13/003; B25J 13/006; G06F 40/205; G06F 40/40; G06N 3/0442; G06N 3/0455; G06N 3/0475; G06V 10/44; G06V 10/764; G06V 10/82; G06V 10/95; G06V 20/188; G06V 20/70; G10L 25/63

(57) ABSTRACT

A system includes a processor configured to receive sensor data from an Internet of Things (IoT) unit including a plurality of sensors installed in farmland, the sensor data being indicative of soil moisture, pH, temperature, crop growth status, and surrounding weather conditions. The processor evaluates a health state of crops and a progress of crop growth by applying a machine learning algorithm to the sensor data using an artificial intelligence (AI) unit. The processor further acquires weather forecast data and market demand data and performs a comprehensive analysis to generate an optimal farm work plan. Based on an analysis result produced by the AI unit, the processor controls agricultural machines including at least an irrigation system, a pesticide spraying drone, and a harvesting robot to automate farm work.

### CROSS-REFERENCE TO RELATED APPLICATION

This application claims the benefit of U.S. Provisional Application No. 63/770,740, filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional agricultural management systems typically rely on fragmented technologies that separately handle sensor monitoring, decision support, and machine control, and therefore fail to provide an integrated, data-driven workflow from field observation to execution of farm operations. In many cases, soil conditions, crop growth status, and surrounding weather conditions are only partially monitored, and external information such as weather forecasts and market demand is not systematically incorporated into operational planning. As a result, farmers are required to manually interpret heterogeneous data sources, determine appropriate timing and amounts for irrigation and pesticide spraying, and schedule harvesting operations based largely on experience and intuition. This manual, experience-dependent approach can lead to suboptimal use of water and agricultural chemicals, delayed or premature harvesting, increased labor burden, and reduced profitability. Furthermore, conventional systems often lack a mechanism that allows a farmer to easily monitor the overall system status in real time and to seamlessly intervene or override automated operations via familiar devices such as smartphones or tablets. Accordingly, there is a need for a smart agriculture system that integrates an Internet of Things (IoT) unit, an artificial intelligence (AI) unit, and a data analysis unit under a unified processor configuration, so as to automatically collect comprehensive field data, evaluate crop health and growth progress using machine learning algorithms, incorporate external weather forecast and market demand data into the analysis, and directly control agricultural machines, while still enabling real-time monitoring and manual intervention by the farmer.

### SUMMARY

In order to solve the above-described problems, the present invention provides a system comprising a processor, wherein the processor is configured to receive, from an IoT unit including a plurality of sensors installed in farmland, sensor data indicative of at least soil moisture, pH, temperature, crop growth status, and surrounding weather conditions, the sensors being configured to measure the soil moisture, the pH, the temperature, the crop growth status, and the surrounding weather conditions. The processor is further configured to evaluate, by an AI unit implemented by the processor, a health state of crops and a progress of crop growth by applying a machine learning algorithm to the sensor data received from the IoT unit, and to acquire external weather forecast data and market demand data, and perform a comprehensive analysis based on the sensor data, the weather forecast data, and the market demand data to generate an optimal farm work plan. The processor is additionally configured to control, by a data analysis unit implemented by the processor, agricultural machines including at least an irrigation system, a pesticide spraying drone, and a harvesting robot based on an analysis result produced by the AI unit, so as to automate farm work. In preferred embodiments, the processor is configured to compare past data and current data related to the farmland in order to evaluate the health state of the crops by using the machine learning algorithm, to predict future weather conditions by using the weather forecast data, and to optimize timing of irrigation and pesticide spraying based on a prediction result of the future weather conditions. In further embodiments, the processor is configured to provide, in the data analysis unit, an interface for controlling the agricultural machines based on the analysis result produced by the AI unit, to enable a farmer to monitor, in real time, a status of the system by using a smartphone or a tablet as a terminal device, and to enable the farmer to perform manual intervention in the control of the agricultural machines through the terminal device when necessary. Through these configurations, the system achieves integrated, automated, and optimizable farm management while retaining flexible human oversight and intervention.

The term “system” refers to an integrated arrangement of hardware and software components, including at least one processor, memory, communication interfaces, sensors, and agricultural machines, which cooperate to perform the functions specified in the claims.

The term “processor” refers to one or more hardware processing units, such as a central processing unit (CPU), a microcontroller, a digital signal processor, or a combination thereof, configured to execute instructions and implement the AI unit, the IoT unit interface, and the data analysis unit.

The term “Internet of Things (IoT) unit” refers to a functional block that includes a plurality of sensors installed in farmland and associated communication components, and that is configured to acquire environmental and crop-related data and transmit the data to the processor.

The term “sensor” refers to a device or module that measures a physical or environmental quantity, such as soil moisture, pH, temperature, crop growth status, or surrounding weather conditions, and outputs the measurement as electrical or digital data.

The term “soil moisture” refers to a quantitative indication of the water content present in the soil of the farmland, which may be expressed as a volumetric water content, a gravimetric water content, or an equivalent index.

The term “pH” refers to a numerical measure of acidity or alkalinity of the soil in the farmland, typically represented on a scale from 0 to 14, where lower values indicate more acidic conditions and higher values indicate more alkaline conditions.

The term “temperature” refers to a measure of thermal conditions in the farmland environment, including at least the temperature of the soil or ambient air, and expressed in an appropriate unit such as degrees Celsius or degrees Fahrenheit.

The term “crop growth status” refers to information indicative of the developmental stage, vigor, morphology, or visual condition of crops, including but not limited to leaf size, color, shape, canopy density, or other parameters derived from sensor or image data.

The term “surrounding weather conditions” refers to environmental parameters in the area of the farmland, including at least temperature, humidity, wind speed, rainfall, and optionally solar radiation or other meteorological factors.

The term “artificial intelligence (AI) unit” refers to a functional block implemented by the processor that applies one or more machine learning algorithms or AI models to input data, in order to evaluate crop health, assess growth progress, and generate analysis results or operational plans.

The term “machine learning algorithm” refers to an algorithm that is trained on data to model relationships or patterns, and that is configured to perform tasks such as prediction, classification, anomaly detection, or optimization without being explicitly programmed with fixed rules.

The term “crop health state” refers to an evaluation of the physiological and pathological condition of crops, including the presence or absence of stress, disease, nutrient deficiency, or other factors affecting crop vitality.

The term “growth progress” refers to the advancement of crops through different growth stages over time, such as germination, vegetative growth, flowering, fruiting, and maturity, as determined from sensor data or models.

The term “external weather forecast data” refers to predictive meteorological information obtained from sources outside the farmland, such as public or private weather services, indicating expected future conditions including temperature, rainfall, humidity, and wind.

The term “market demand data” refers to information indicative of current or forecasted demand for agricultural products in a market, including price trends, volume demands, seasonal variations, or buyer preferences.

The term “comprehensive analysis” refers to a processing operation in which the AI unit combines and evaluates multiple categories of data, including sensor data, weather forecast data, and market demand data, in order to generate integrated conclusions or optimal operational plans.

The term “optimal farm work plan” refers to a schedule or set of recommended agricultural operations, such as irrigation, pesticide application, fertilization, and harvesting, that is determined by the AI unit to be most favorable under given conditions and constraints, with respect to objectives including yield, quality, cost, and resource efficiency.

The term “data analysis unit” refers to a functional block implemented by the processor that processes analysis results produced by the AI unit and translates them into control commands for agricultural machines, and optionally manages interfaces to such machines.

The term “agricultural machine” refers to any mechanized device or system used to perform farm operations, including but not limited to irrigation systems, pesticide spraying drones, and harvesting robots.

The term “irrigation system” refers to equipment configured to supply water to crops or soil in the farmland, including components such as pumps, valves, pipes, sprinklers, or drippers, and control elements for regulating timing and amount of water application.

The term “pesticide spraying drone” refers to an unmanned aerial vehicle equipped with a spraying mechanism and a pesticide reservoir, configured to apply pesticides over designated areas according to control commands.

The term “harvesting robot” refers to an automated or semi-automated machine capable of harvesting crops from the field, including components for navigation, crop detection, cutting or picking, and collection.

The term “automate farm work” refers to performing at least part of agricultural operations, such as irrigation, pesticide application, or harvesting, under automatic control of the processor and the data analysis unit, without requiring continuous manual operation by a human operator.

The term “past data” refers to historical records of sensor measurements, operational logs, and related information collected from the farmland over a preceding period of time.

The term “current data” refers to sensor measurements and system status information acquired for the farmland in a recent or present time frame, and used for real-time or near-real-time analysis.

The term “future weather conditions” refers to predicted environmental states inferred from external weather forecast data, including anticipated values of temperature, humidity, rainfall, and related meteorological variables.

The term “timing of irrigation and pesticide spraying” refers to the specific points or intervals in time at which irrigation operations and pesticide application operations are to be started, continued, adjusted, or stopped.

The term “interface for controlling the agricultural machines” refers to hardware and/or software components that allow the processor to send control signals or commands to agricultural machines and optionally receive status or feedback from the machines.

The term “terminal device” refers to a user-operated device such as a smartphone or a tablet that is capable of communicating with the system, displaying system status information, and transmitting user inputs for monitoring and control.

The term “manual intervention” refers to an action by a farmer or human operator, performed through the terminal device, to change, approve, reject, or override automated control actions or plans generated by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

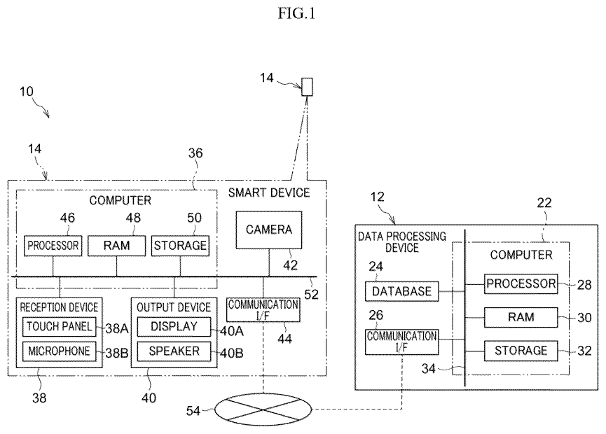

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

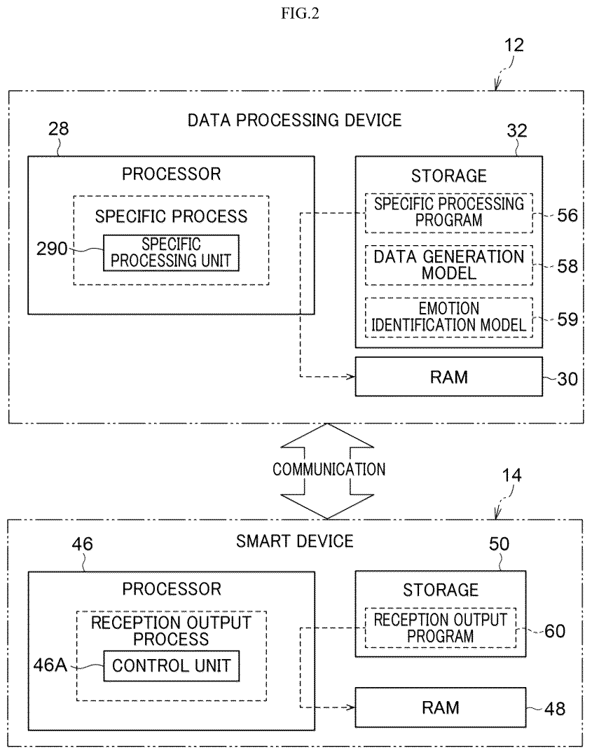

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional smart farming systems generally perform rule-based or static machine learning processing on agricultural sensor data and then present fixed recommendations to an operator. In such systems, a computing apparatus typically evaluates environmental data and crop growth data with a prediction model and outputs predetermined control rules for machinery, while a user interface merely displays results and allows for simple manual overrides. These approaches suffer from several technical problems from the viewpoint of computer technology.

First, conventional systems do not provide a unified computational framework that dynamically converts heterogeneous numerical data, external data, and user feedback into structured natural language instructions suitable for consumption by a generative artificial intelligence model. Sensor streams, time-series data, and prediction outputs are usually kept in numerical formats and are not systematically transformed into context-rich prompt sentences. As a result, the processing apparatus cannot effectively exploit large-scale language models to generate flexible, situation-aware operation plans, and the system remains limited to rigid, preprogrammed decision trees.

Second, known systems lack an integrated feedback mechanism in which user interventions and execution outcomes are automatically encoded as constraints and preference information, and are then reused to condition subsequent computation. Typical override actions or manual adjustments by a farmer are treated as ad hoc exceptions and are not machine-readable inputs to the core planning algorithms. Consequently, the computing apparatus cannot learn from a user's historical interventions, cannot automatically adjust the parameters of prediction models, and cannot systematically inject user preferences or operational constraints into future decision-making. This results in repetitive manual corrections, higher computational overhead for recalculation, and suboptimal use of computing resources.

Third, traditional architectures separate predictive machine learning from higher-level planning logic, causing an inefficient pipeline. A prediction engine may output time-series forecasts, while a separate module manually encodes those forecasts into textual guidelines or fixed-format reports. This fragmented processing leads to redundant conversions between data representations, increased memory usage, and latency due to repeated data transfers and formatting operations. Moreover, without a coherent mechanism to automatically translate prediction results and external data into optimized control parameters, the system often requires custom logic for each new device or scenario, which complicates software maintenance and reduces scalability.

Fourth, existing systems generally do not allow a generative artificial intelligence model to directly generate machine-usable operation plans that respect device-level constraints and resource limitations. High-level narrative recommendations may be produced, but they are not consistently transformed into structured control parameters and constraint-aware schedules.

There is no standardized process to automatically append statistical summaries, constraint conditions, and performance data to prompt sentences in a way that the computing apparatus can reliably interpret and apply when creating device control signals.

Therefore, there is a need for an improved computing technique that integrates numerical prediction processing, prompt sentence generation for a generative artificial intelligence model, automatic extraction of control parameters, and feedback-based adaptation in a unified processor-centric architecture. Such a technique should: (i) reduce the computational and development burdens associated with manually bridging numerical models and language models; (ii) enhance the ability of the processor to generate operation plans that are immediately convertible into executable control signals; (iii) systematically reflect user preferences, resource constraints, and device performance into subsequent computation; and (iv) improve the overall efficiency, responsiveness, and scalability of computer-based agricultural management systems.

The specific processing by the specific processing unit 290 of the data processing device 12 in Example 1 is realized by the following means.

The present invention provides a server comprising a processor configured to acquire environmental information and growth information from at least one information acquisition apparatus arranged in an agricultural facility and to perform numerical data preprocessing on the environmental information and the growth information so as to generate feature data, the processor further configured to execute prediction processing by using a machine learning algorithm based on the feature data and external information, to convert a prediction result of the machine learning algorithm and the external information into a natural language expression, to generate a prompt sentence including the natural language expression, and to input the prompt sentence to a generative artificial intelligence model so as to obtain a response sentence describing an agricultural work plan and a resource allocation policy, the processor further configured to extract control parameters for at least one work apparatus from the response sentence, to generate an operation plan of the work apparatus based on the control parameters, and to generate and transmit a control signal for the work apparatus based on the operation plan, the processor further configured to cause a display and input interface to present at least one of the environmental information, the prediction result, the response sentence, and the operation plan, to receive from a user at least one of an approval input, a modification input, and a cancellation input with respect to the operation plan, and to feed back the approval input, the modification input, and the cancellation input to an operation plan generation process and to a generative artificial intelligence processing process by generating the prompt sentence with preference information of the user and past intervention history of the user added as contextual information. This enables the computing architecture to automatically transform heterogeneous sensor data and external data into context-rich prompt sentences for a generative artificial intelligence model, to convert narrative responses into device-level control parameters and executable schedules, and to iteratively adapt prediction models and prompt generation based on user feedback and operational performance, thereby improving computational efficiency, scalability, and responsiveness of the server-centered control system.

The term “environmental information” refers to digital data representing physical conditions in or around an agricultural facility, including but not limited to soil moisture, acidity, temperature, humidity, wind, precipitation, and other measurable environmental variables.

The term “growth information” refers to digital data representing a biological state or development stage of a cultivated organism, including but not limited to crop growth stages, plant health indicators, biomass estimations, and visually detected characteristics such as leaf color or shape.

The term “information acquisition apparatus” refers to a hardware apparatus configured to collect environmental information and growth information, including one or more sensing devices, imaging devices, or measurement devices installed in or near an agricultural facility.

The term “agricultural facility” refers to a managed agricultural environment in which cultivated organisms are grown, including but not limited to open fields, greenhouses, orchards, plantations, or similar managed cultivation areas.

The term “numerical data preprocessing” refers to computational operations performed on raw digital data to prepare the data for subsequent analysis, including but not limited to data cleaning, interpolation, normalization, aggregation, and conversion into feature data.

The term “feature data” refers to a structured representation of preprocessed numerical or categorical values derived from raw data, suitable as input to a machine learning algorithm, and including, for example, normalized variables, statistical summaries, and encoded categorical indicators.

The term “external information” refers to digital data obtained from a source external to the agricultural facility, including but not limited to weather forecast data, market data, price data, or external statistical data relevant to agricultural planning.

The term “prediction processing” refers to a computational operation in which a machine learning algorithm is applied to feature data and, optionally, external information in order to generate predicted values, classifications, risk scores, or time-series forecasts.

The term “machine learning algorithm” refers to a computational model that is trained or parameterized using data to perform predictive or analytical tasks, including but not limited to regression models, classification models, time-series models, or ensemble models.

The term “natural language expression” refers to textual data represented in a human language, such as a sentence or paragraph, generated or processed by the processor to describe information in a form understandable by human readers or language models.

The term “prompt sentence” refers to a natural language expression, optionally combined with structured context, that is formatted for input to a generative artificial intelligence model to elicit a corresponding output.

The term “generative artificial intelligence model” refers to a computational model configured to generate new data, such as text, based on an input prompt, including but not limited to language models that produce narrative descriptions, plans, or recommendations.

The term “response sentence” refers to a natural language expression generated by a generative artificial intelligence model in response to a prompt sentence, the response sentence including at least a portion of an agricultural work plan or resource allocation policy.

The term “agricultural work plan” refers to a structured description of agricultural operations to be executed during a time period, including but not limited to irrigation operations, application of chemicals, harvesting operations, and associated timing and sequencing.

The term “resource allocation policy” refers to a set of guidelines or rules specifying how resources such as water, chemicals, labor, or machinery should be distributed or scheduled over time or among locations.

The term “control parameters” refers to numerical or symbolic values configured to determine the behavior of a work apparatus, including but not limited to operation start times, durations, intensities, setpoints, target locations, or dosage quantities.

The term “work apparatus” refers to a controllable machine or device configured to perform an agricultural operation, including at least one of an irrigation apparatus, a chemical spraying apparatus, and a harvesting apparatus.

The term “operation plan” refers to a structured set of control parameters and scheduling information defining when and how a work apparatus is to be operated.

The term “control signal” refers to a data signal generated by the processor and transmitted to a work apparatus or a controller thereof, the signal encoding at least one control parameter for execution by the work apparatus.

The term “display and input interface” refers to a combination of hardware and software configured to present information to a user and to receive input from the user, including but not limited to a graphical user interface on a terminal device.

The term “approval input” refers to user-provided input indicating acceptance of at least a portion of an operation plan as generated by the processor.

The term “modification input” refers to user-provided input indicating a change to at least a portion of an operation plan, including edits to control parameters or scheduling information.

The term “cancellation input” refers to user-provided input indicating that at least a portion of an operation plan is to be invalidated or not executed.

The term “preference information of the user” refers to data representing a user's desired operational tendencies or priorities, including but not limited to preferences regarding yield levels, risk levels, chemical usage, or water usage.

The term “past intervention history of the user” refers to data indicating historical instances of user approvals, modifications, or cancellations of operation plans and corresponding contexts in which such interventions occurred.

The term “contextual information” refers to auxiliary information associated with a prompt sentence, including at least one of preference information of the user, past intervention history of the user, statistical summaries, or constraint conditions, used to influence the behavior of a generative artificial intelligence model.

The term “statistical information” refers to aggregated or derived data values computed from historical records, including but not limited to averages, distributions, variances, trends, and correlations related to yield, quality, weather, or price.

The term “medium- to long-term agricultural management plan” refers to an agricultural work plan and resource allocation policy that extends over a relatively long time horizon, such as multiple weeks, months, or seasons, and encompasses strategic decisions on planting, inputs, labor, and risk mitigation.

The term “evaluation information” refers to data representing a user's assessment of a recommendation, plan, or executed operation, including ratings, qualitative comments, or categorical evaluations.

The term “performance information of the work apparatus” refers to data describing actual operation of a work apparatus, including executed control parameters, completion status, resource consumption, and realized effects.

The term “learning data” refers to data used to train or update a machine learning algorithm, including input features, target outputs, and associated labels or feedback.

The term “constraint conditions” refers to limitations or bounds imposed on generated plans or control parameters, including but not limited to allowable loss amounts, allowable chemical use amounts, water use limitation amounts, or regulatory limits.

In one embodiment, a server implements the claimed system by executing one or more programs on a hardware platform including at least one central processing unit (CPU), at least one graphics processing unit (GPU), a main memory, a nonvolatile storage device, and a communication interface. The server runs an operating system such as a general-purpose server operating system, and executes application software implemented, for example, in a programming language with numerical computation libraries. The server is connected via a communication network to at least one terminal and to a plurality of information acquisition apparatuses and work apparatuses installed in an agricultural facility.

The server acquires environmental information and growth information by communicating with information acquisition apparatuses that include sensors, cameras, and other measurement devices. The server receives, for example, packets transmitted via a message protocol such as a publish-subscribe protocol or via a web-based protocol. Each packet includes a device identifier, a timestamp, and one or more measured values such as soil moisture, soil temperature, ambient temperature, humidity, wind speed, rainfall, or encoded representations of images capturing crop leaves. The server stores raw time-series data in a time-series data store and stores image data in an object data store. By using these specific data stores and by indexing each record with a combination of field identifier and timestamp, the server reduces access time for subsequent batch processing and enables efficient retrieval of temporally aligned heterogeneous data.

The server performs numerical data preprocessing on the environmental information and the growth information by executing data-transformation procedures. The server loads data segments from the time-series data store into a numerical array structure, and interpolates missing values using, for example, linear interpolation or last-observation-carried-forward methods. The server then applies normalization, such as z-score normalization, to convert raw measurements into dimensionless feature values. For each field and each time slot, the server computes statistical summaries including moving averages, standard deviations, minimum and maximum values, and cumulative rainfall. The server stores these derived values in a feature table, where each record is a feature vector indexed by a field identifier and a time index. This structuring into a feature table reduces redundancy: the server does not repeatedly recompute statistics when generating predictions, thereby improving computation efficiency and reducing processor load.

The server processes image data representing growth information by executing a trained neural network model for computer vision. The server resizes each image to a fixed resolution, converts color channels to a normalized color space, and constructs a tensor with dimensions corresponding to batch size, channels, width, and height. The server inputs this tensor to a convolutional neural network (CNN) architecture, such as a residual network including convolution layers with kernel sizes, batch normalization layers, and rectified linear unit activation functions. The server obtains from this CNN both intermediate feature maps and a final output vector representing, for example, probabilities of multiple disease classes and a growth-stage classification. The server writes these disease-risk scores and growth-stage labels into the feature table as additional components of the feature vectors. By embedding vision-derived indicators into unified feature vectors, the server avoids performing independent and uncoordinated analysis for images and sensor data, and thus improves both prediction accuracy and latency of the integrated pipeline.

The server executes prediction processing by using a machine learning algorithm that consumes the feature table and external information. In one embodiment, the server employs a sequence model such as a recurrent neural network or long short-term memory (LSTM) network to model temporal dependencies. The server structures the input data as time-ordered sequences per field, where each time step includes the feature vector described above and aligned external information such as forecasted temperature and rainfall, or expected market demand. The server applies a trained LSTM network that includes an input layer mapping feature vectors to a hidden dimension, one or more LSTM layers with a specified number of hidden units, and an output layer projecting hidden states to target variables such as soil moisture predictions, disease risk trajectories, or yield forecasts.

The server trains the machine learning algorithm offline or periodically online by minimizing an objective function such as a mean squared error between predicted and observed continuous variables, or a cross-entropy loss for categorical outputs. The server updates network weights by gradient-based optimization, such as stochastic gradient descent or an adaptive method, using backpropagation through time. The server can also apply data augmentation techniques such as random temporal cropping or noise injection to sensor values, improving generalization and robustness. By explicitly modeling temporal dynamics and training on large historical datasets, the server achieves improved prediction accuracy compared with static rule-based systems, which directly leads to more precise operation plans and reduced resource waste.

The server converts prediction results and external information into a natural language expression by generating textual summaries. The server maps numerical outputs such as predicted soil moisture, disease probability, and yield range into linguistic phrases by applying template-based formatting rules and threshold-based descriptors. For example, if a disease risk score exceeds a high-risk threshold, the server generates a phrase such as “high risk of leaf disease in Field A within the next 3 days.” The server concatenates such phrases along with concise descriptions of forecasted weather conditions and market demand into a structured explanation.

The server generates a prompt sentence including this natural language expression. The server may embed, for instance, tables of summarized values in textual form and may include explicit instructions to a generative AI model. As specific examples, the server can generate a prompt sentence such as:

“Based on the following data for Field A: average soil moisture 18% over the last 7 days, predicted soil moisture below 15% for the next 3 days, and no rainfall forecast, propose a detailed irrigation plan for the next week. Output recommended irrigation start times, duration, and water volume per hectare for each day.”

The server can also generate a prompt sentence such as:

“Based on the crop growth data from the past 5 years, predict the optimal irrigation schedule for the next harvest season. Use the attached time-series data for soil moisture, temperature, and rainfall, and output a day-by-day irrigation plan with recommended water volume per hectare.”

Further, the server can generate a strategic prompt sentence such as:

“Using the last 5 years of yield, weather, and price data, design a planting plan for the next season that maximizes profit while limiting pesticide use to 50% of the current level.”

The server inputs the generated prompt sentence to a generative AI model. The server accesses the generative AI model either as a remote service via an application programming interface or as a locally hosted large language model running on GPU hardware. The server encodes the prompt sentence into tokens and feeds them into a transformer-based architecture comprising an embedding layer, multiple self-attention layers, and a linear output layer. The generative AI model outputs a sequence of tokens that the server decodes into a textual response sentence. This response sentence can contain, for example, a natural language description of an agricultural work plan and a resource allocation policy, including detailed per-day irrigation schedules, recommended pesticide types and dosages, harvest windows, and priority ordering of tasks.

The server extracts control parameters for at least one work apparatus from the response sentence by applying post-processing algorithms. The server parses the response sentence using rule-based text parsing, pattern matching, or an auxiliary language model configured specifically for information extraction. The server identifies phrases corresponding to numeric quantities and time expressions, and converts them into structured data fields such as start time, end time, duration, flow rate, pesticide dosage, GPS coordinates, and assigned field segments. By mapping linguistic tokens to predefined parameter types, the server creates a structured operation plan represented, for example, as an array of operation records, each containing apparatus identifier, target area, start time, and parameter values.

The server generates and transmits control signals to work apparatuses based on the operation plan. The server formats each operation record into a device-specific command message, such as a message including a command type, a target device identifier, and the control parameters.

The server transmits these messages over the communication interface using a protocol supported by the work apparatus controllers. The work apparatuses, such as irrigation controllers, chemical spraying drones, or harvesting robots, interpret the received control signals and actuate valves, pumps, sprayers, or cutting mechanisms accordingly. In this way, the server's internal processing is not confined to abstract computation but is causally linked to physical operations in the agricultural facility.

The server causes a display and input interface on the terminal to present environmental information, prediction results, response sentences, and operation plans. The terminal can be implemented as a smartphone or tablet executing a client application. The server transmits display data in structured form, and the terminal renders charts, tables, and timelines of planned operations. The terminal receives user inputs, such as approval input, modification input, or cancellation input, via touch gestures or forms. When the user approves an operation plan, the terminal transmits an approval signal to the server. When the user modifies specific parameters, such as reducing irrigation volume by a percentage or delaying a spray operation, the terminal sends the modified values as update messages to the server. When the user cancels an operation, the terminal sends a cancellation message causing the server to refrain from generating corresponding control signals.

The user can also interact directly with the generative AI model through the terminal. The user may input a prompt sentence such as:

“Based on the current field conditions, including soil moisture, crop growth stage, and the 7-day weather forecast, propose a detailed work plan for the next week. Break the plan down by day and by task, including irrigation, fertilization, pest control, and weeding.” The terminal transmits this prompt sentence to the server, which may append additional contextual data before submitting it to the generative AI model. The server then returns the generated text to the terminal for display. In this embodiment, the generative AI model operates not merely as a user-facing assistant, but as a programmable component in the overall control pipeline that generates machine-usable information.

The server feeds back approval input, modification input, and cancellation input to the operation plan generation process and to the generative AI processing process. The server logs each user intervention together with the context in which it occurred, including environmental conditions, original predictions, and original recommendations. The server updates preference information of the user, such as a preference for lower water usage or a preference for avoiding specific chemicals, by inferring patterns from repeated modifications.

The server stores past intervention history in association with user identifiers and field identifiers. When the server generates a new prompt sentence, the server appends to the prompt sentence a description of the user preferences and constraints, such as “The user prefers lower pesticide usage and is willing to accept 5% lower yield” or “Water usage must not exceed a specified volume per week.”

By embedding such contextual information into the prompt sentence, the server causes the generative AI model to generate responses that inherently respect user-specific constraints.

This approach differs from manual adjustment by the user after each recommendation; instead, the system dynamically adjusts the generative AI model's behavior via prompt engineering and parameter tuning, leading to fewer iterations and lower communication overhead between terminal and server. As a result, the processing pipeline exhibits improved latency and reduced computational waste, because fewer re-computations and corrections are required.

The server additionally uses evaluation information and performance information of the work apparatuses to update learning data for the machine learning algorithm. For example, after each harvest, the server collects realized yield, quality grades, and resource consumption. The server compares these outcomes with the predicted values and computes residual errors. The server then extends the training dataset with these new samples and periodically retrains the LSTM or other models to reduce prediction error. The server can also include intervention signals as additional inputs or labels, so the models learn how user preferences and constraints influence outcomes. By continuously retraining, the server achieves a reduction in prediction error over time, which directly improves optimization of operation plans.

In a variation, the server uses a gradient boosting model or random forest instead of, or in addition to, an LSTM. The server then constructs input feature vectors that capture temporal context via engineered features (e.g., lagged values and moving windows) rather than recurrent structures. The same infrastructure for prompt generation and response parsing remains applicable. In another variation, the server hosts the generative AI model locally and fine-tunes the model on domain-specific corpora, such as agricultural guidelines and internal logs, to better align outputs with device constraints and data structures. Fine-tuning can be accomplished by optimizing an objective that penalizes outputs that are difficult to parse or that conflict with known device capability descriptors.

The server thus executes a coordinated series of specialized data structures and algorithms: time-series stores, feature tables, CNNs for image processing, LSTMs or other models for temporal prediction, transformer-based generative models for text generation, and rule-based or model-assisted parsers for extracting control parameters. Because the server uses these modules in a tightly integrated and non-conventional sequence-numerical prediction feeding into prompt sentence generation, generative AI output feeding into structured control parameter extraction, and user feedback being converted into contextual constraints—the system achieves technical improvements in processing speed, prediction accuracy, and resource allocation quality compared with conventional rule-based automation.

The terminal functions primarily as a visualization and input device in this embodiment. The terminal does not perform heavy numerical computation, thereby reducing energy consumption on the terminal side, while the server, optimized for parallel numerical operations and model inference on accelerated hardware, performs all intensive processing. The communication protocol between the server and the terminal allows for incremental updates and compressed representations of data, reducing bandwidth usage and enabling responsive user interaction.

The user supervises system operation by reviewing predicted outcomes, AI-generated recommendations, and current and planned actions of work apparatuses. The user can override or refine suggestions, and these interventions are incorporated into the server's internal models in a structured manner, rather than being treated as ad hoc exceptions. Over time, the system thereby adapts to user behavior and environmental patterns, and the server's processing pipeline becomes more efficient, both in computation and in real-world resource usage.

In summary, the server, the terminal, and the user cooperate in such a way that the internal technical architecture of the server is improved: data paths are optimized, model pipelines are integrated, and the generative AI model is systematically controlled via prompt sentences constructed from structured prediction outputs and user feedback. This configuration yields not only improved agricultural decisions but also concrete improvements in computer technology, including reduced processing time through precomputation of feature data, improved model accuracy through continuous retraining with execution feedback, and reduced network traffic through fewer iterations of planning and correction.

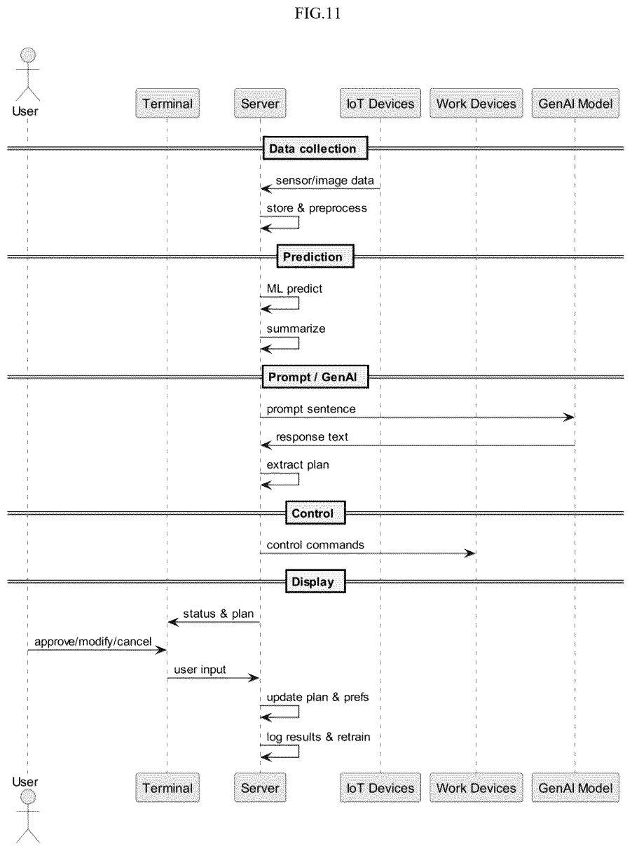

The following describes the processing flow using FIG. 11.

### Step 1

The server receives raw environmental information and growth information from information acquisition apparatuses installed in an agricultural facility.

The input to the server in this step is a plurality of data packets, each including at least a device identifier, a timestamp, and one or more measured values such as soil moisture, soil temperature, ambient temperature, humidity, wind speed, rainfall, or image data of crops.

The server parses each packet, validates formats and value ranges, and stores numerical values into a time-series data store and image data into an object data store.

The server associates each stored record with a field identifier and a unified time index to create an internal key for later joins.

The output of this step is a set of normalized raw records in persistent storage, indexed by device identifier, field identifier, and timestamp.

### Step 2

The server acquires external information such as weather forecast data and market data from external data sources.

The input to the server in this step is at least one external data response in a structured format, received from an external server via a network protocol.

The server sends request messages specifying geographic region and time horizon, receives forecasted temperature, rainfall, and other variables, and converts these values into a standard unit system.

The server stores the external information in a relational data store or time-series data store, aligning each external record with the same time index and region identifier used for field data.

The output of this step is a set of external information records that can be joined with environmental information and growth information based on time and location.

### Step 3

The server performs numerical data preprocessing on the environmental information, the growth information, and the external information to construct feature data.

The input to the server in this step is a collection of raw time-series records and aligned external information records retrieved from the data stores.

The server groups records by field identifier and time interval, fills missing data points using interpolation or last-observation-carried-forward methods, and applies normalization such as z-score scaling to each measurement type.

The server computes derived features including moving averages, standard deviations, cumulative rainfall, and lagged values for selected variables.

The server assembles these values into feature vectors for each field and time index and writes them into a feature table.

The output of this step is a feature table in which each row represents a feature vector associated with a specific field and time.

### Step 4

The server processes image-based growth information to derive disease-risk indicators and growth-stage labels.

The input to the server in this step is a batch of image data records retrieved from the object data store, along with associated field identifiers and timestamps.

The server resizes each image to a fixed resolution, normalizes pixel intensities, and constructs a tensor for input to a convolutional neural network.

The server executes the convolutional neural network on the tensor, obtaining, for each image, a set of class probabilities for disease types and a classification of growth stage.

The server converts these probabilities and classifications into numerical indicators and categorical labels and adds them as additional dimensions to the corresponding feature vectors in the feature table.

The output of this step is an updated feature table in which each feature vector includes both sensor-derived features and image-derived features.

### Step 5

The server executes prediction processing by applying a machine learning algorithm to the feature table and the external information.

The input to the server in this step is a set of feature vectors organized as time-ordered sequences per field, together with aligned external information values for future time intervals.

The server feeds each sequence into a trained model, such as a recurrent neural network or a gradient boosting model, and computes predicted values including future soil moisture, disease risk levels, expected yield, and potential harvest windows.

The server evaluates these predictions against internal thresholds and model confidence scores and stores the prediction outputs in a prediction table along with metadata such as prediction horizon and model version.

The output of this step is a prediction table containing, for each field and time interval, predicted environmental conditions, disease risks, and production metrics.

### Step 6

The server generates natural language expressions summarizing the prediction results and the external information.

The input to the server in this step is the prediction table and the relevant external information for each field.

The server applies formatting rules and templates that map numerical ranges and categorical labels to descriptive phrases, such as “high disease risk within the next three days” or “soil moisture predicted to fall below threshold.”

The server concatenates and structures these phrases into coherent summaries for each field and planning horizon, ensuring that key predicted events and constraints are clearly expressed.

The output of this step is a set of text summaries that describe predicted conditions and constraints in a human-readable form.

### Step 7

The server generates at least one prompt sentence for a generative AI model based on the natural language expressions and structured prediction data.

The input to the server in this step is the text summaries produced in Step 6, together with selected numerical values and user preference information retrieved from stored records.

The server embeds the summaries and key numerical indicators into prompt templates, forming prompt sentences that instruct the generative AI model to produce detailed work plans and resource allocation policies.

The server, for example, may generate a prompt sentence such as: “Based on the following data for Field A: average soil moisture 18% over the last 7 days, predicted soil moisture below 15% for the next 3 days, and no rainfall forecast, propose a detailed irrigation plan for the next week. Output recommended irrigation start times, duration, and water volume per hectare for each day.”

The output of this step is a set of prompt sentences, each associated with a field and a planning scenario.

### Step 8

The server submits the prompt sentences to a generative AI model and obtains response sentences describing agricultural work plans and resource allocation policies.

The input to the server in this step is the set of prompt sentences generated in Step 7.

The server transmits each prompt sentence to the generative AI model via an application programming interface or internal function call and receives generated text as a response sentence.

The server decodes and segments the response sentences into components such as recommended tasks, timing, quantities, and priorities.

The output of this step is a set of response sentences, each containing a proposed agricultural work plan and associated resource allocation guidance.

### Step 9

The server extracts control parameters for work apparatuses from the response sentences.

The input to the server in this step is the set of response sentences obtained in Step 8.

The server parses each response sentence using a parsing routine that identifies time expressions, quantity expressions, apparatus types, and target locations.

The server converts identified textual elements into structured control parameters, such as start times, end times, flow rates, pesticide dosages, and geographic coordinates.

The server organizes these control parameters into operation records, each record specifying a work apparatus identifier and associated parameters.

The output of this step is a structured operation plan consisting of multiple operation records ready for device-level scheduling.

### Step 10

The server generates and transmits control signals to work apparatuses based on the operation plan.

The input to the server in this step is the structured operation plan created in Step 9.

The server formats each operation record into a device-specific command message that encodes control parameters and timing information.

The server sends these command messages over a communication interface to controllers of irrigation systems, chemical spraying apparatuses, or harvesting apparatuses.

The output of this step is a stream of control signals received and executed by the work apparatuses to perform physical operations in the agricultural facility.

### Step 11

The terminal displays environmental information, prediction results, response sentences, and operation plans to the user.

The input to the terminal in this step is display data transmitted from the server, including numerical summaries, text descriptions, and schedule information.

The terminal renders charts for time-series data, tables for prediction results, and lists or calendars for operation plans on a graphical user interface.

The terminal also displays the response sentences from the generative AI model so that the user can review the rationale and structure of the recommended work plans.

The output of this step is a visual presentation that enables the user to understand current conditions, future predictions, and planned operations.

### Step 12

The user reviews the displayed information and provides approval input, modification input, or cancellation input regarding at least part of an operation plan.

The input to the user in this step is the information presented on the terminal, including predicted risks and planned actions.

The user, based on experience or external constraints, may confirm that a recommended plan is acceptable, adjust parameters such as start times or quantities, or cancel specific operations.

The user enters these decisions via the terminal interface, for example by tapping approval buttons, sliding controls, or editing form fields.

The output of this step is user input data representing approvals, modifications, or cancellations of operation records.

### Step 13

The terminal transmits the user input data to the server for further processing.

The input to the terminal in this step is the user's actions on the interface controls.

The terminal converts the actions into structured messages including operation identifiers and new parameter values or status codes indicating approval or cancellation.

The terminal sends these messages to the server over the communication network using an application protocol suitable for reliable delivery.

The output of this step is a stream of user input messages received by the server.

### Step 14

The server updates the operation plan and control scheduling based on the user input data.

The input to the server in this step is the set of approval, modification, and cancellation messages received from the terminal.

The server matches each message to the corresponding operation record in the operation plan and updates control parameters or execution flags accordingly.

The server may remove cancelled operations, adjust times and quantities for modified operations, and mark approved operations as ready for execution.

The output of this step is an updated operation plan that reflects the user's interventions and that will govern subsequent control signals.

### Step 15

The server updates user preference information and intervention history, and uses these data to enrich future prompt sentences.

The input to the server in this step is the log of user approvals, modifications, and cancellations, together with contextual information such as environmental conditions and original recommendations.

The server analyzes patterns in the user interventions, infers preferences such as a tendency to reduce pesticide amounts or to avoid operations during certain hours, and stores these preferences in association with the user and the relevant fields.

The server records the intervention history and constructs descriptive statements summarizing these preferences and constraints.

The server then incorporates such statements into the context of future prompt sentences, so that subsequent calls to the generative AI model reflect the learned preferences and constraints.

The output of this step is an updated set of user preference profiles and enriched prompt sentences that guide the generative AI model toward user-aligned and constraint-aware plans.

### Step 16

The server collects evaluation information and performance information from completed operations and uses them to update learning data for the machine learning algorithm.

The input to the server in this step is post-operation data including executed control parameters, actual water usage, realized yields, quality metrics, and user evaluations of recommendation quality.

The server joins these post-operation data with original predictions and planned parameters and computes residuals between predicted and actual outcomes.

The server appends these labeled samples to the training dataset and periodically retrains the prediction models to reduce prediction error and improve calibration.

The output of this step is an updated model parameter set and an expanded learning dataset, which collectively improve the accuracy and robustness of future prediction processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

The specific processing by the specific processing unit 290 of the data processing device 12 in Application Example 1 is realized by the following means.

The term “system” refers to a combination of hardware and software components that cooperate to perform data acquisition, data processing, interaction with a generative AI model, and control of actuators.

The term “processor” refers to one or more hardware processing units, such as a central processing unit, a graphics processing unit, or a programmable logic device, configured to execute instructions stored in a memory.

The term “detection device” refers to an electronic device configured to measure a physical quantity in a spatial region and output corresponding measurement data as observation information.

The term “physical quantity” refers to a measurable property of a physical environment, such as temperature, humidity, flow rate, pressure, illumination, occupancy, or any other environmental or operational parameter.

The term “observation information” refers to data representing environmental states or operational states of a spatial region, obtained from one or more detection devices.

The term “spatial region” refers to any physical area or zone in which observation information is collected and in which actuators are deployed for control, such as a site, a building, or an infrastructure segment.

The term “statistical information” refers to data derived from observation information through aggregation or analysis, including but not limited to averages, sums, variances, standard deviations, extrema, or other statistical metrics.

The term “feature information” refers to numerical or categorical data derived from observation information or statistical information and formatted as input to a machine learning algorithm.

The term “machine learning algorithm” refers to a computational model that processes feature information to infer patterns, predict future values, or estimate indicators, including but not limited to neural networks, regression models, decision trees, or ensemble models.

The term “future state” refers to a predicted condition or value of an environmental or operational parameter at a time later than a current time, obtained by processing observation information with a machine learning algorithm.

The term “risk indicator” refers to a numerical or categorical value representing a likelihood or severity of an adverse or undesirable event in the spatial region, derived from observation information or a future state.

The term “natural language” refers to a human language, such as English, that uses words and grammar understandable by human users and is processable by a generative AI model.

The term “prompt sentence” refers to a text string in a natural language that describes a situation, constraints, and objectives and is provided as an input prompt to a generative AI model to elicit a response.

The term “request data” refers to a structured data object including at least a prompt sentence and optionally additional metadata, which is transmitted to a generative AI model.

The term “generative AI model” refers to an artificial intelligence model configured to generate natural language text in response to input prompt sentences, such as a large language model.

The term “response sentence” refers to a text string in a natural language generated by a generative AI model in response to a prompt sentence.

The term “structured information” refers to data formatted according to a predefined structure, such as key-value pairs, tables, or hierarchical objects, that represent a control policy or an operation plan.

The term “control policy” refers to a set of rules, parameters, or strategies that define how actuators should be operated under certain conditions in order to achieve a specified objective.

The term “operation plan” refers to a time-sequenced or condition-based specification of actions to be executed by actuators or control systems within the spatial region.

The term “control command” refers to an instruction or set of instructions generated by the processor and transmitted to an actuator to change a configuration, a setpoint, or a state of the actuator.

The term “actuator” refers to a device or system that can change a physical condition in the spatial region in response to a control command, including but not limited to fluid transport apparatuses, lighting apparatuses, air conditioning apparatuses, and mobile body control apparatuses.

The term “fluid transport apparatus” refers to a device or system that transports or regulates a fluid, such as a pump, a valve, or a fluid distribution system.

The term “lighting apparatus” refers to a device or system that generates or controls illumination, such as a luminaire, a lighting controller, or a lighting network.

The term “air conditioning apparatus” refers to a device or system that controls temperature, humidity, or air quality in a space, such as a heating, ventilation, or cooling unit.

The term “mobile body control apparatus” refers to a device or system that controls movement of a mobile entity, such as a vehicle controller, a robotic controller, or a traffic signal controller.

The term “storage” refers to one or more memory units configured to store data persistently or temporarily, including volatile and non-volatile memories and external storage media.

The term “generation rules for the prompt sentence” refers to algorithms, templates, or parameters that define how observation information, statistical information, and future states are converted into a prompt sentence.

The term “terminal device” refers to an electronic device operated by a human user to display information from the processor and to input instructions, such as a personal computer, a handheld device, or a communication terminal.

The term “display information” refers to data prepared by the processor for visual or graphical presentation on a terminal device, including summaries, indicators, and detailed records.

The term “application status” refers to data indicating whether, how, and to what extent control commands have been executed by actuators.

The term “intervention instruction information” refers to data input by an operator via a terminal device that indicates approval, rejection, or modification of one or more control commands.

The term “apparatus category” refers to a classification label indicating a type of target device to which a control command or parameter applies, such as a category for a lighting device, an air conditioning device, or a fluid transport device.

The term “amount of change of a setting value” refers to a numerical value indicating an increment, decrement, or target value adjustment to be applied to a configuration parameter of an actuator.

The term “application condition” refers to a constraint or criterion specifying when or under what circumstances a control command or an element of a control policy is to be executed.

The term “designation information” refers to operator input specifying, for each element of a control command, whether the element is approved, rejected, or changed, and optionally including modified parameter values.

In one embodiment, a server implements the claimed system as a combination of hardware and software components that execute on a computing platform including at least one central processing unit (CPU), an optional graphics processing unit (GPU), a main memory, a non-volatile storage device, and a network interface. The server uses a general-purpose operating system such as a server-class operating system, a database management system such as a relational database or a time-series database, and middleware for message communication such as a message broker or a web server. The server executes application software modules written in a high-level programming language and configured to perform data acquisition, data transformation, numerical computation, prompt sentence generation, interaction with a generative AI model, parsing of natural language responses, and generation of control commands for actuators.

The server receives observation information from a plurality of detection devices deployed in a physical region. The detection devices include, for example, sensors that measure traffic flow, environmental conditions, energy consumption, or occupancy states. Each detection device transmits measurement data to the server via a communication network using protocols such as a publish-subscribe protocol or a request-response protocol. The server implements a communication module that listens on specific network ports, authenticates the sending devices, and stores raw observation information in structured records. Each record includes at least a device identifier, a timestamp, a measurement type indicator, and a measurement value. The server stores these records in a storage subsystem such as a relational database table or a time-series database measurement, thereby creating a persistent and queryable data structure optimized for time-indexed retrieval.

The server processes the stored observation information using a data-processing module that employs numerical computation libraries such as numerical array libraries and data-frame libraries. The server groups the raw records by measurement type and spatial region, and calculates statistical information such as averages, sums, minima, maxima, standard deviations, and quantiles over predefined time windows. The server also computes derived features such as moving averages, exponential moving averages, trend indicators, and correlation coefficients between different measurement types. These operations are performed using vectorized computations on in-memory arrays, which reduces the number of memory accesses and improves processing speed compared to naive iterative approaches.

The server converts the statistical information into feature information formatted as numerical vectors suitable for input to machine learning algorithms. In one implementation, the server constructs, for each control target (for example, a specific intersection, building, or zone), a feature vector by concatenating values such as recent time-series samples, lagged values, and derived indicators. The server normalizes each feature using precomputed scaling parameters (for example, mean and standard deviation) stored in the database. This normalization reduces numerical instability and improves convergence and prediction accuracy of the machine learning models.

The server executes a machine learning algorithm such as a neural network to estimate a future state or a risk indicator for the spatial region. In one embodiment, the server uses a feed-forward neural network or a recurrent neural network (for example, a long short-term memory network) implemented on top of a machine learning framework. The server loads a trained model, which comprises multiple layers including an input layer, one or more hidden layers, and an output layer, with each layer having learned weight parameters and bias parameters stored in files on the storage device. During inference, the server performs matrix multiplications, bias additions, and activation functions (for example, rectified linear units or sigmoid functions) on the normalized feature vectors. If a GPU is available, the server offloads large matrix operations to the GPU using a GPU computing library, thereby improving throughput and reducing latency for high-volume prediction tasks.

The server calculates, from the model outputs, future states such as predicted traffic volumes, predicted pollutant concentrations, or predicted power demand, and risk indicators such as congestion risk scores, air-quality risk scores, or peak-demand overrun probabilities. The server stores these outputs in structured database tables indexed by time and spatial region.

The use of a consistent data schema for these predictions allows the server to efficiently join and filter data across multiple time horizons and types of risk indicators, thereby enabling downstream modules to access relevant information with low query complexity.

The server generates a prompt sentence in a natural language for a generative AI model based on the statistical information and the estimated future state or risk indicator. The server uses a template-based prompt generation module that assembles textual fragments according to predefined templates. The module transforms numeric values into human-readable phrases, inserts them into sentence slots, and appends explicit statements of constraints and optimization objectives. For example, when heavy congestion is detected at a controlled intersection, the server constructs a prompt sentence such as:

“Current traffic conditions at Intersection B show that the average delay per vehicle is 90 seconds, the average queue length on the northbound approach is 35 vehicles, and the average queue length on the eastbound approach is 20 vehicles. The current signal plan uses a fixed 100-second cycle with equal green times for all approaches. The objective is to reduce average delay and prevent queue spillback on the northbound approach over the next 60 minutes. Please propose a detailed traffic signal plan for the next 60 minutes, including cycle length, green times for each approach, and any recommended phase sequence changes, in a structured, machine-readable format.”

Similarly, when deteriorating air quality is observed, the server may generate a prompt sentence such as:

“Air quality in the central district has been deteriorating. PM2.5 concentrations have remained between 55 and 70 micrograms per cubic meter for the last 2 hours, while the target threshold is 35 micrograms per cubic meter. Traffic volume on the main avenue is currently 1800 vehicles per hour, and there is a scheduled public event starting in 3 hours. The objective is to reduce PM2.5 exposure for residents and event participants over the next 6 hours. Please propose a set of specific, feasible measures, including possible temporary traffic regulations, adjustments to public transport, and recommendations for informing residents, expressed in concise bullet points suitable for implementation by the control system.”

In the case of energy-demand control, the server may generate a prompt sentence such as: “Energy demand in the business district is projected to exceed the contracted peak limit of 50 megawatts between 15:00 and 17:00. Current demand at 14:30 is 48 megawatts, with approximately 60 percent from air conditioning systems, 25 percent from lighting, and 15 percent from elevators and other equipment. Building comfort constraints allow air conditioning setpoint increases of up to 2 degrees Celsius in noncritical zones and lighting reductions of up to 30 percent in corridors and lobbies. Please propose an optimal, step-by-step plan to limit peak demand to 50 megawatts or less over the next 2 hours, including recommended setpoint changes and load-shifting actions, in a structured format that specifies time, target equipment categories, and percentage adjustments.”

By formalizing the prompt sentence generation using explicit templates and rule-based transformations of structured data into natural language, the server ensures consistency, reduces ambiguity, and increases the likelihood that the generative AI model returns responses that can be reliably parsed into machine-executable structures. This constitutes a technical improvement in the interaction between structured data processing modules and generative AI models.

The server transmits the generated prompt sentence as part of request data to a generative AI model endpoint. The generative AI model is, for example, a transformer-based large language model that has been trained on large corpora of text. The server specifies operational parameters such as maximum response length, response format constraints, and temperature.

In some embodiments, the server uses special instructions in the prompt sentence (for example, “Output only JSON with the following keys.”) or a constrained decoding method available in the generative AI framework to bias the model toward generating responses that follow a particular schema. This reduces the amount of post-processing needed and diminishes the incidence of malformed responses, thereby enhancing the reliability and performance of the overall system.

The server receives a response sentence from the generative AI model and parses the response sentence into structured information. The server uses a parsing module that implements syntactic and semantic parsing rules, including pattern matching against expected keywords, extraction of numerical values, and validation of time expressions and equipment categories.

When the generative AI model is instructed to output responses in a structured text format resembling key-value pairs or a restricted markup, the parsing module can convert the response into a structured representation such as a hierarchical object with fields for time, target apparatus categories, parameter adjustment values, and application conditions. The parser also performs consistency checks, such as verifying that the sum of green times does not exceed the cycle length in a signal plan, or that recommended setpoint changes stay within allowed bounds.

The server translates the structured information into control commands suitable for actuators deployed in the spatial region. The actuators may be traffic controllers, building management systems, lighting controllers, or other control devices. The server maintains a mapping database that associates logical apparatus categories and locations with specific network addresses and protocol parameters. Based on this mapping, the server encodes control commands in the protocol format required by each actuator, such as command messages for lighting control, setpoint adjustment commands for air conditioning systems, or phase timing commands for traffic controllers. The server transmits the control commands through the network interface and optionally receives acknowledgments and status reports from the actuators.

The server stores, in the storage subsystem, the entire sequence of data used and generated in the process, including the original observation information, the statistical information, the feature vectors, the machine learning model outputs, the prompt sentences, the response sentences, the structured information extracted from the responses, the generated control commands, and the actuator feedback. By maintaining these records in a unified schema, the server enables offline analysis and retraining. The server periodically executes batch processes using data-processing frameworks to evaluate the performance of applied control strategies. For example, the server can compare target metrics (such as desired queue lengths or peak demand limits) with actual outcomes and compute error statistics and improvement ratios.

The server uses these performance statistics to update the machine learning models and the generation rules for the prompt sentences. In one embodiment, the server retrains the neural networks using supervised learning, where target labels are derived from actual observed outcomes, and loss functions such as mean squared error or cross-entropy are minimized using gradient descent optimization. The server updates model weights and biases and redeploys the updated models. In another embodiment, the server refines the prompt generation templates based on empirical evaluation of which prompt structures produce more easily parsable and more effective control plans from the generative AI model. This feedback loop constitutes a technical improvement of the computational pipeline itself, as it adaptively optimizes both predictive accuracy and the quality of AI-generated control policies.

A terminal implements a user interface that allows a user to monitor the system state and intervene in the control process. The terminal is, for example, a personal computer, a tablet, or a smart device executing a web application or a native application. The terminal receives display information from the server including observation information summaries, predicted future states, active control policies, and the application status of control commands. The terminal renders this information in visual form, such as maps with color-coded congestion or pollution levels, time-series charts of energy consumption, tables of current device states, and textual summaries of recent AI-generated plans.

The terminal displays, in association with each other, the prompt sentences transmitted to the generative AI model, the corresponding response sentences, and the control commands generated from those responses. The user can select a specific plan and view detailed information including time schedules, affected actuators, and expected effect metrics. The terminal provides user interface elements that allow the user to approve, reject, or modify individual elements of a control command set. For instance, the user may approve altered signal timings at certain intersections while rejecting changes at others, or may reduce the magnitude of a proposed temperature increase in a particular zone.

The terminal transmits the user's intervention instruction information to the server. The server reconciles the intervention instructions with pending commands and adjusts the set of commands to be applied, updating internal status flags to indicate which actions are enabled and which are suppressed. The server stores the intervention instruction information along with the associated prompt sentences, response sentences, and control commands, thereby enabling later analysis of human-machine collaboration patterns. This stored information can be used to refine both machine learning models and prompt generation rules, for example by biasing future AI-generated plans away from patterns that are frequently rejected by human operators.

A user operates the terminal to supervise and refine the system's operation. The user may be a domain expert, such as an infrastructure operator. The user interprets the displayed information, reviews AI-generated proposals in the context of local knowledge and policies, and issues intervention instructions when necessary. The system's design enables the user to focus on high-level decisions while delegating the low-level numerical computations and control signal generation to the server. At the same time, the explicit linkage between each control command and its originating prompt and response allows the user to audit and trust the AI-assisted decision-making process.

From a technical perspective, this embodiment improves computer technology in several ways. The server's combination of predictive models and generative AI models, linked through a structured prompt sentence generation mechanism and a robust parsing mechanism, enables the system to transform high-dimensional, heterogeneous sensor data into actionable and verifiable control commands. Unlike a mere automation of human decision-making, the system implements non-conventional data structures, specialized feature engineering, and neural network architectures optimized for real-time inference and control decisions, thereby achieving higher prediction accuracy and faster response times compared to manual or rule-only systems. The template-based and data-driven prompt generation and parsing reduce communication overhead between modules, because only compact prompt sentences and structured responses are exchanged with the generative AI model, rather than raw sensor data streams. Moreover, the feedback loop that logs and analyses outcomes to refine both predictive models and prompt rules is implemented at the level of computational algorithms and data management, improving the efficiency, robustness, and technical performance of the computer-implemented control system itself.

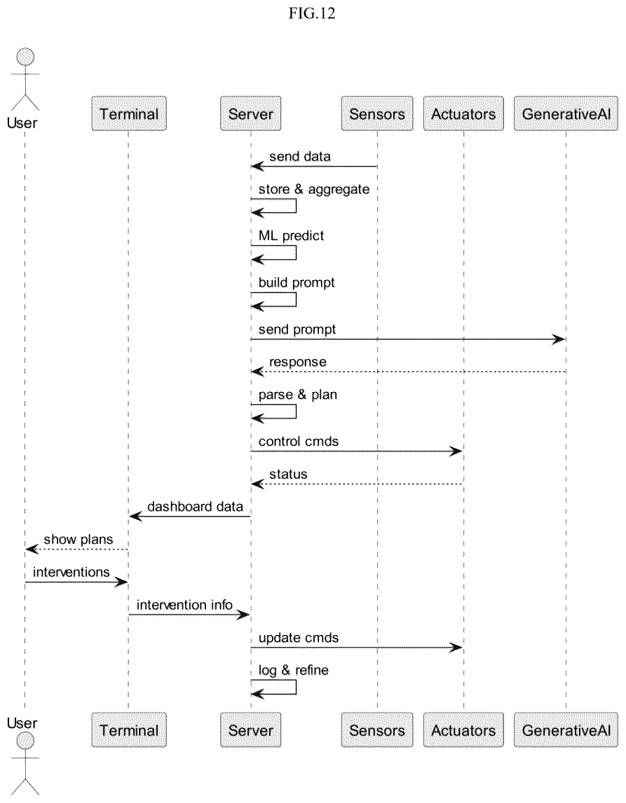

The following describes the processing flow using FIG. 12.

### Step 1

The server receives raw observation information from detection devices. The input to this step is a plurality of sensor messages, each including at least a device identifier, a timestamp, a measurement type, and a measurement value. The server, via a communication module, accepts these messages over a network protocol, verifies message integrity, and decodes each payload into a structured record. The server performs basic validation, such as checking that timestamps are within an acceptable range and that measurement values are within predefined physical limits. The server then writes the validated records into a storage structure, such as a time-indexed table in a database. The output of this step is a set of normalized, stored observation records ready for further processing.

### Step 2

The server aggregates the stored observation information into statistical information. The input to this step is the set of raw observation records retrieved from storage over a specified time window and for specified measurement types and regions. The server groups the records by measurement type and spatial region and performs numerical computations such as averaging, summing, and computing minima, maxima, and standard deviations. The server also performs data cleansing operations, such as removing outliers using statistical thresholds and interpolating missing values using methods like linear interpolation. The output of this step is a set of statistical records, each including identifiers of the spatial region and measurement type, the aggregation time window, and calculated statistics such as mean, variance, and trend indicators.

### Step 3

The server transforms the statistical information into feature vectors for machine learning. The input to this step is the aggregated statistical records generated in the previous step, along with configuration data defining feature layouts and normalization parameters. The server constructs, for each control target, a feature vector by concatenating selected statistical values, time-series segments, lagged values, and derived metrics. The server applies normalization operations, such as subtracting pre-stored means and dividing by pre-stored standard deviations, to each feature component. The output of this step is a set of normalized feature vectors, each associated with a specific control target and time index, ready to be supplied to a machine learning model.

### Step 4

The server performs predictive computation using a machine learning model. The input to this step is the set of normalized feature vectors and a trained model configuration that includes network architecture, layer parameters, and activation functions. The server loads the model weights and biases from storage into memory and executes forward propagation on each feature vector. The server computes matrix multiplications between feature vectors and weight matrices, adds bias vectors, and applies nonlinear activation functions layer by layer.

If available, the server offloads these matrix operations to a GPU to accelerate the computations. The output of this step is a set of model outputs representing predicted future states or risk indicators, such as predicted traffic volumes, predicted pollutant concentrations, or peak-demand probabilities, each linked to a control target and future time.

### Step 5

The server derives decision-oriented indicators from the model outputs. The input to this step is the set of predicted future states and risk indicators produced in the previous step, along with predefined thresholds and evaluation rules. The server compares predicted values against thresholds to compute discrete risk levels or alert flags. The server also calculates derived metrics, such as congestion scores based on predicted queue length and delay, pollution risk scores based on predicted concentrations and duration of exceedance, or energy risk scores based on predicted demand relative to contractual limits. The server writes these indicators into a dedicated database table. The output of this step is a structured set of decision indicators suitable for use in prompt generation and control logic.

### Step 6

The server generates a prompt sentence for a generative AI model. The input to this step is the decision indicators, the underlying statistical information, and configuration templates defining natural language patterns. The server selects an appropriate template based on the type of situation (for example, traffic congestion, air-quality deterioration, or high energy demand). The server then fills template placeholders with specific numeric values and contextual information, such as current averages, predicted future values, time ranges, and constraints. As a result, the server transforms structured data into a coherent natural-language description. For example, the server may generate a prompt sentence such as:

“Current traffic conditions at Intersection B show that the average delay per vehicle is 90 seconds, the average queue length on the northbound approach is 35 vehicles, and the average queue length on the eastbound approach is 20 vehicles. The current signal plan uses a fixed 100-second cycle with equal green times for all approaches. The objective is to reduce average delay and prevent queue spillback on the northbound approach over the next 60 minutes. Please propose a detailed traffic signal plan for the next 60 minutes, including cycle length, green times for each approach, and any recommended phase sequence changes, in a structured, machine-readable format.”

The output of this step is at least one prompt sentence in natural language, associated with metadata such as target region and objective.

### Step 7

The server sends the prompt sentence to a generative AI model and receives a response sentence. The input to this step is the prompt sentence and connection parameters for the generative AI model endpoint. The server encapsulates the prompt sentence into request data and transmits the request to the generative AI model over a network using a suitable application protocol. The server specifies parameters such as maximum response length and style constraints. The generative AI model processes the prompt and returns a natural-language response sentence or a structured text. The server receives this response, verifies that it conforms to expected format constraints (for example, presence of required sections or keyword markers), and logs both the prompt and the response. The output of this step is the response sentence produced by the generative AI model, stored and ready for parsing.

### Step 8

The server parses the response sentence into structured information. The input to this step is the response sentence and a set of parsing rules or grammars corresponding to the expected output format. The server applies pattern matching to identify tokens representing time intervals, device categories, parameter names, and parameter values. The server converts textual representations of numbers and times into normalized numeric and temporal formats.

The server additionally checks logical consistency, such as ensuring that the sum of time allocations does not exceed a specified cycle time or that recommended parameter changes are within allowable bounds. The output of this step is structured information, such as a set of action objects, each specifying a time, a target apparatus category, a parameter adjustment amount, and an application condition.

### Step 9

The server converts the structured information into actuator-specific control commands. The input to this step is the structured information and a configuration database that maps logical apparatus categories and locations to concrete actuator identifiers and communication protocols. The server iterates over each action object and looks up the corresponding actuator endpoints and command syntax. The server formats control commands according to the target protocol (for example, a command message for a traffic controller or a setpoint adjustment message for a building control system). The server attaches scheduling information, such as start and end times, to each command. The output of this step is a series of protocol-specific control commands, organized by actuator and time.

### Step 10

The server transmits the control commands to actuators and records feedback. The input to this step is the prepared set of control commands and network connection information for each actuator. The server establishes connections to the respective actuator interfaces, transmits the commands, and waits for acknowledgments or status messages. The server records transmission results, such as success codes or error codes, along with timestamps, in the storage subsystem. The server also updates internal state flags to indicate which actions are active, pending, or failed. The output of this step is updated actuator states and logged execution records linking commands to their application status.

### Step 11

The server prepares display data for the terminal. The input to this step is the observation information, statistical information, decision indicators, prompt sentences, response sentences, structured information, control commands, and execution logs previously stored. The server aggregates these data into compact representations suitable for visualization, such as summary metrics, lists of recent actions, and associations between each control plan and its originating prompt and response. The server formats the data as structured messages for the user interface, including explanations of why particular control commands were generated. The output of this step is a set of display payloads containing data for dashboards, detail views, and audit views.

### Step 12

The terminal displays the received information to the user. The input to this step is the display payloads transmitted from the server. The terminal decodes these payloads and renders visual elements such as charts, tables, maps, and text panels. The terminal shows current and predicted conditions (for example, congestion levels or energy demand), the content of the prompt sentences sent to the generative AI model, the corresponding response sentences, and the derived control commands. The terminal also highlights applied and pending plans to clearly indicate system behavior. The output of this step is a graphical user interface that presents the system state and AI-derived recommendations in a human-understandable form.

### Step 13

The user reviews the displayed information and issues intervention instructions. The input to this step is the visual representation of observation data, predictions, prompt sentences, response sentences, and control commands shown on the terminal. The user examines, for example, a particular traffic control plan or energy-saving plan, assesses its suitability, and interacts with UI components such as checkboxes, sliders, or buttons. The user can approve or reject each proposed action or adjust parameters like green time lengths or temperature setpoint changes. The output of this step is a set of intervention instruction inputs that encode the user's decisions for each element of the control commands.

### Step 14

The terminal transmits the intervention instruction information to the server. The input to this step is the user's approvals, rejections, and modifications collected by the UI logic. The terminal serializes these instructions into a structured message that references the original control commands and their elements. The terminal sends this message to the server over a secure communication channel. The output of this step is a received intervention instruction message at the server side.

### Step 15

The server applies the intervention instructions and updates control behavior. The input to this step is the intervention instruction message and the set of planned or active control commands. The server correlates each intervention instruction with its corresponding control command or action object. The server disables commands that have been rejected, updates parameters for commands that have been modified, and confirms commands that have been approved. If necessary, the server generates additional commands to cancel or override previously sent instructions. The server stores the association among the prompt sentence, the response sentence, the original control commands, and the intervention instructions in a persistent log. The output of this step is an updated set of control commands to be applied and an enriched audit record capturing human-machine interaction.

### Step 16

The server logs data for performance evaluation and model refinement. The input to this step is the full history of observation information, predictions, risk indicators, prompt sentences, response sentences, structured actions, control commands, actuator feedback, and intervention instructions accumulated over time. The server organizes this data into datasets suitable for offline analysis, aligning control events with subsequent observed outcomes. The server computes performance metrics such as reduction in congestion, deviation between predicted and actual values, and acceptance rates of AI-generated recommendations. The server then uses these metrics to prepare training datasets for retraining or fine-tuning its predictive models and to adjust the templates and rules used for prompt sentence generation. The output of this step is updated model parameters, refined prompt generation rules, and improved configuration data that enhance the accuracy, efficiency, and reliability of subsequent processing cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional smart agriculture systems typically acquire environmental data from field sensors, perform crop-state estimation using machine learning, and generate recommendations or control signals for agricultural machinery. However, such systems usually treat all users uniformly and do not adapt the level of automation, the presentation of recommendations, or the internal use of generative AI models to the user's current cognitive or emotional state. As a result, when a user is experiencing high stress, fatigue, or anxiety, conventional systems may still deliver frequent notifications, dense technical text, or fully automatic machine control, which can overload the user's attention, cause confusion, and reduce trust in the system. Conversely, when a user is highly motivated and capable of handling complex information, conventional systems often fail to provide deeper analysis, multiple strategy options, or sufficiently rich explanations, thereby underutilizing the user's capacity and the system's analytical capabilities.

From a computer-technology perspective, existing systems lack an integrated computational framework that (i) continuously infers user emotional state from heterogeneous digital signals (operation logs, text, voice), (ii) uses that inferred state as a control variable inside the server-side decision logic, and (iii) dynamically modulates both human-facing outputs and machine-facing control commands, including the internal structure and content of prompt sentences provided to a generative AI model. In typical architectures, the generative AI model is invoked with static, hand-crafted prompt sentences that are independent of user state, and the downstream control pipeline treats the natural language output as opaque text, with limited or ad hoc extraction of actionable parameters.

This leads to several technical problems. First, on the data-processing side, the system does not exploit feedback from user interaction and emotion estimation to regulate data volume, presentation complexity, or control policy, which results in inefficient use of computational resources (for example, unnecessary generation of long, complex responses and high-frequency notifications). Second, on the model-inference side, the absence of structured, emotion-aware prompt generation causes the generative AI model to produce responses that are not optimized for user comprehension or acceptance, increasing the need for repeated queries and corrections. Third, on the control-command generation side, conventional systems lack a robust mechanism to convert free-form natural language recommendations into normalized control parameters that respect safety boundaries while being conditionally gated by user approval based on the inferred emotional state.

Accordingly, there is a need for a computer-implemented technique that improves the internal operation of the server by (1) estimating a multidimensional emotional state index from user interaction and content data, (2) generating emotion-adaptive prompt sentences for a generative AI model, (3) adjusting presentation mode and frequency for user interfaces, and (4) deriving and regulating machine-control commands in accordance with an emotion-dependent control policy. Such a technique should reduce cognitive load and unnecessary interactions, improve the relevance and acceptance of AI-generated proposals, and provide a more robust, state-aware pipeline from sensor data and user signals to both natural language output and machine control, thereby constituting an improvement in computer technology itself.

The specific processing by the specific processing unit 290 of the data processing device 12 in Example 2 is realized by the following means.

The present invention provides a server comprising a processor configured to acquire observation information from a plurality of detection devices installed in an agricultural environment, the observation information including at least soil condition information, plant growth information, and environmental condition information, to acquire external provision information including at least forecast information and demand information, and to generate agricultural work proposal information on the basis of the observation information, growth history information, and the external provision information, and to store the observation information, the growth history information, and the external provision information in a storage medium as accumulation information; the processor configured to acquire operation history information of a terminal device operated by a user, and text information and voice information input by the user, to extract behavioral feature information and emotional feature information from the operation history information, the text information, and the voice information, and to calculate, by using a machine learning algorithm, an emotional state index including at least one of stress degree, fatigue degree, anxiety degree, and motivation degree; the processor configured to determine, on the basis of the emotional state index, the observation information, the growth history information, and the external provision information, contents, an expression style, and a detail degree of a prompt sentence to be input to a generative AI model, to generate the prompt sentence, to input the prompt sentence to the generative AI model, and to obtain, from the generative AI model, agricultural work proposal information in a natural language form; the processor configured to determine, on the basis of the emotional state index, a control policy including at least one of a presentation mode and a presentation frequency of the agricultural work proposal information for the user, and an automatic control range for agricultural machinery, and to control, on the basis of the control policy, a mode of generation and transmission of control commands for the agricultural machinery; the processor configured to generate, on the basis of the control policy and the agricultural work proposal information obtained from the generative AI model, control command information for agricultural machinery including at least one of an irrigation device, an application device, a spraying device, and a harvesting device, and to transmit the control command information to the agricultural machinery via a communication path; and the processor configured to control, on the basis of the control policy, a user interface of the terminal device such that a presentation mode and a presentation frequency of the agricultural work proposal information are adjusted in accordance with the emotional state index, and to cause the terminal device to present the agricultural work proposal information to the user and to acquire approval operation information or modification operation information from the user via the terminal device, and to update the control command information and the accumulation information on the basis of the approval operation information or the modification operation information. This enables the server to implement an emotion-aware, closed-loop control architecture in which user interaction data, emotion estimation, prompt sentence generation for a generative AI model, user interface adaptation, and machine-control command synthesis are tightly integrated, thereby improving computational efficiency, robustness, and user acceptance relative to conventional smart agriculture systems.

The term “system” refers to an arrangement of one or more servers, one or more terminal devices, one or more agricultural machines, and one or more detection devices, together with communication paths and storage media, that cooperatively perform data acquisition, processing, presentation, and control operations.

The term “server” refers to an information processing apparatus, or a group of interconnected information processing apparatuses, including at least one processor, at least one memory, and at least one communication interface, configured to execute programs that implement data acquisition, emotion estimation, prompt sentence generation, generative AI model invocation, control policy determination, and control command generation.

The term “processor” refers to one or more hardware processing circuits, such as a central processing unit, a graphics processing unit, a digital signal processor, or a combination thereof, configured to execute instructions and perform arithmetic, logical, data transfer, and control operations.

The term “detection device” refers to a hardware measurement unit, installed in an agricultural environment, that is configured to obtain physical or biological quantities related to soil conditions, plant growth, or environmental conditions, such as soil moisture, soil chemical properties, temperature, humidity, light intensity, or image information.

The term “observation information” refers to digital data representing measurement values acquired by the detection devices, including at least identifiers of the detection devices, timestamps, and measured quantities related to soil conditions, plant growth, and environmental conditions.

The term “soil condition information” refers to observation information related to a physical or chemical state of soil, including at least one of soil moisture, soil temperature, soil acidity, soil salinity, or nutrient concentration.

The term “plant growth information” refers to observation information indicating a growth state of a plant, including at least one of plant height, leaf area, biomass index, phenological stage, visual appearance derived from images, or disease symptom indicators.

The term “environmental condition information” refers to observation information indicating conditions around an agricultural field, including at least one of air temperature, humidity, rainfall, wind speed, solar radiation, or other meteorological parameters.

The term “external provision information” refers to information obtained from a source outside the agricultural field, including forecast information and demand information that are provided by external devices, services, or data stores.

The term “forecast information” refers to information indicating a predicted or expected future value of at least one environmental condition or market-related parameter, including at least meteorological forecasts such as predicted temperature, rainfall, and solar radiation.

The term “demand information” refers to information indicating a demand state or price trend related to an agricultural product, including at least market price, demand volume, demand trend, or distribution volume.

The term “growth history information” refers to information representing a past record of cultivation for a crop, including at least historical yields, past irrigation amounts, past application amounts of fertilizers or chemicals, past disease occurrences, and past management operations.

The term “accumulation information” refers to data stored in a storage medium, including at least observation information, growth history information, and external provision information, which are available for subsequent processing by the processor and by machine learning models.

The term “operation history information” refers to data representing operations performed by a user on a terminal device, including at least screen identifiers, function identifiers, operation types, timestamps, and screen residence times.

The term “terminal device” refers to a user-accessible information processing device, such as a portable communication device, a tablet computing device, or a personal computing device, including at least a display, an input unit, and a communication interface, configured to present information to a user and accept user input.

The term “text information” refers to character string data input by a user via a terminal device, including at least free-form comments, questions, instructions, or feedback messages.

The term “voice information” refers to digital audio data representing a user's speech, recorded or captured by a terminal device or another input device.

The term “behavioral feature information” refers to feature values derived from operation history information, including at least aggregated counts of operations, cancellation operations, or help requests, and measures of screen residence time or interaction frequency.

The term “emotional feature information” refers to feature values derived from text information and voice information, including at least vector representations computed by natural language processing algorithms and acoustic features computed from voice signals.

The term “machine learning algorithm” refers to a computational method that adjusts internal parameters of a model based on training data to perform tasks such as classification, regression, or prediction, including at least neural networks, support vector machines, or ensemble methods.

The term “emotional state index” refers to a quantitative or categorical representation of a user's psychological state, including at least one of a stress degree, a fatigue degree, an anxiety degree, and a motivation degree, expressed as a numeric score or level.

The term “stress degree” refers to a component of the emotional state index indicating an estimated intensity of psychological or physiological stress of a user.

The term “fatigue degree” refers to a component of the emotional state index indicating an estimated level of tiredness or reduced energy of a user.

The term “anxiety degree” refers to a component of the emotional state index indicating an estimated level of worry, nervousness, or apprehension of a user.

The term “motivation degree” refers to a component of the emotional state index indicating an estimated level of willingness, interest, or engagement of a user in performing agricultural tasks.

The term “generative AI model” refers to a machine learning model, including at least a neural network model, configured to receive a prompt sentence as input and to generate natural language text as output, where the generated text includes at least agricultural work proposal information or explanations.

The term “prompt sentence” refers to a natural language instruction or context string that is input to the generative AI model and that specifies at least a field state, a user emotional state, a required output format, and a requested content type, thereby conditioning the generation of output text by the generative AI model.

The term “contents of a prompt sentence” refers to information elements included in the prompt sentence, such as crop type, sensor summaries, forecast summaries, user questions, requested number of proposals, and requested explanation requirements.

The term “expression style of a prompt sentence” refers to linguistic characteristics of the prompt sentence, including at least word choice, technical term usage, politeness level, and sentence structure complexity.

The term “detail degree of a prompt sentence” refers to a degree of specificity or granularity of information requested in the prompt sentence, including at least the number of tasks to propose, the depth of explanation, and whether multiple alternative strategies are requested.

The term “agricultural work proposal information” refers to natural language text or structured data describing recommended agricultural operations, including at least types of operations, timing, frequency, amounts, target areas, and rationales.

The term “control policy” refers to data representing a set of rules or parameters used to govern presentation and control behavior of the system, including at least a presentation mode, a presentation frequency, and an automatic control range for agricultural machinery.

The term “presentation mode” refers to a configuration of a user interface that determines a level of detail and layout of agricultural work proposal information, including at least a simple mode and a detailed mode.

The term “presentation frequency” refers to a rate or interval at which agricultural work proposal information or notifications are presented to a user via a terminal device.

The term “automatic control range” refers to limits or conditions specifying, for each type of agricultural operation, whether and to what extent the server may generate and transmit control commands to agricultural machinery without requiring user confirmation, including at least an automatic mode, a semi-automatic mode, and a manual mode.

The term “agricultural machinery” refers to one or more actuating devices configured to perform agricultural operations, including at least an irrigation device, an application device, a spraying device, and a harvesting device.

The term “irrigation device” refers to an apparatus configured to supply water to an agricultural field under control of received control commands.

The term “application device” refers to an apparatus configured to apply materials such as fertilizers, soil conditioners, or growth regulators to an agricultural field under control of received control commands.

The term “spraying device” refers to an apparatus configured to spray liquids or particles, such as agrochemicals or nutrients, onto crops or fields under control of received control commands.

The term “harvesting device” refers to an apparatus configured to harvest crops from an agricultural field under control of received control commands.

The term “control command information” refers to structured data specifying operation parameters for agricultural machinery, including at least an operation type, an operation amount, an execution time, an execution duration, and a target area, which are transmitted from the server to the agricultural machinery.

The term “user interface” refers to a functional component executed on a terminal device that presents agricultural work proposal information, control command candidates, and related content to a user and that accepts user inputs such as approvals, modifications, rejections, and comments.

The term “approval operation information” refers to data indicating that a user has accepted a proposed agricultural operation or control command, including at least an identification of the proposal and a timestamp.

The term “modification operation information” refers to data indicating that a user has changed one or more parameters of a proposed agricultural operation or control command, including at least modified amounts, times, or target areas.

The term “control command candidate” refers to a provisional control command information item that is generated by the server but is held pending until approval information is received from the user in a semi-automatic mode.

The term “safety range” refers to a permissible range for a numerical parameter related to agricultural machinery operation, defined based on agronomic, environmental, or device constraints, within which automatic control is allowed by the system.

In one embodiment, a server, a terminal, and agricultural machinery cooperate to implement the claimed system. The server executes software components for data acquisition, feature extraction, emotion estimation, prompt sentence generation for a generative AI model, natural language proposal generation, control policy determination, and control command synthesis. The terminal executes a user interface for presenting agricultural work proposal information and acquiring user input. The agricultural machinery executes physical operations such as irrigation, application of materials, spraying, and harvesting according to control commands transmitted from the server.

The server uses one or more general-purpose processors and, in some embodiments, one or more graphics processing units. The server includes a main memory, a nonvolatile storage device, a network interface, and an operating system such as a general-purpose server operating system. The server uses an application framework such as a web server and an application runtime and executes application programs written in a general-purpose programming language. The server uses a relational database management system to store structured data and uses a document-oriented database to store semi-structured data. The server uses a message queue system for streaming data processing. The server uses a numerical computation library such as a tensor operation library, a data-frame processing library, a natural language processing library, and a deep learning framework to perform arithmetic, statistical, and learning operations.

The terminal uses a mobile operating system and a dedicated application configured to communicate with the server by secure communication. The terminal includes a display, a touch panel or another pointing input device, a microphone, and a wireless communication interface. The terminal presents agricultural work proposal information and control command candidates received from the server and acquires user input such as approvals, modifications, and free-text or voice comments. The terminal formats operation history information and transmits the formatted information to the server.

The server stores observation information, growth history information, and external provision information in structured records. The server, for example, stores observation information as time series in a database table having fields including at least: sensor identifier, field identifier, timestamp, soil moisture value, soil temperature value, soil acidity value, air temperature value, humidity value, rainfall value, and optional derived indices. The server stores growth history information as records including cultivation period, crop variety, fertilization amounts, irrigation amounts, application of agrochemicals, disease or pest occurrence, yield, and quality indices. The server stores external provision information in tables holding forecast information such as predicted temperature, predicted rainfall, and demand information such as current reference price, moving average price, and demand index values.

The server acquires operation history information from the terminal and stores it in a database table with fields including user identifier, terminal identifier, screen identifier, operation type identifier, timestamp, and screen residence time. The server stores text information as character sequences associated with user identifiers, time information, and context identifiers such as question types or feedback types. The server stores voice information as file paths or object identifiers and associates them with user identifiers and timestamps.

The server generates behavioral feature information by applying data-frame operations to the operation history information. The server aggregates, for example, operation counts per unit time, cancellation operation counts, help-request counts, and averages and variances of screen residence times. The server uses a data-frame processing library to create a feature vector for each user consisting of numeric elements representing these aggregated values. The server generates emotional feature information from text information by applying a tokenizer and an embedding algorithm of a natural language processing library. The server, for example, uses a subword tokenizer to convert text into token identifiers and applies a pre-trained language model that outputs a contextual vector for each token. The server reduces the sequence of token vectors to a fixed-length text embedding by, for example, taking an average of token vectors or taking the vector corresponding to a designated classification token. The server generates emotional feature information from voice information by computing acoustic feature vectors, such as Mel-frequency cepstral coefficients and their temporal statistics, using an audio processing library.

The server concatenates the behavioral feature information, the text embedding, and the acoustic feature vector into a unified feature vector. The server inputs this unified feature vector into a neural network model implemented in a deep learning framework. In one embodiment, the neural network model is a feed-forward multilayer perceptron with an input layer matching the dimension of the unified feature vector, at least one hidden layer with a non-linear activation function such as a rectified linear unit, and an output layer producing real-valued scores corresponding to stress degree, fatigue degree, anxiety degree, and motivation degree. In another embodiment, the model includes an attention mechanism to weight different feature groups. The server uses model parameters obtained by supervised training on labeled data containing ground-truth emotional state labels. The server uses a cost function such as mean squared error or cross-entropy loss during training and updates model weights by stochastic gradient descent or a variant such as Adam. The server may apply data augmentation, for example, by adding small noise to numeric features or by using synonym replacement in text, to improve generalization.

The server normalizes the raw outputs of the neural network to a fixed range, for example, between 0 and 1 for each emotional dimension, thus forming the emotional state index. The server stores the emotional state index for each user in a user-emotion table, together with a timestamp. The server thereby establishes a persistent computational representation of user emotional state that is updated whenever new operation history information, text information, or voice information is acquired.

The server determines a control policy by reading the emotional state index and applying rule-based logic that defines thresholds and modes. In one embodiment, the server uses a rule table in which rows specify conditions on stress degree, anxiety degree, and motivation degree and columns specify output parameters such as presentation mode, presentation frequency, and automatic control range. The server evaluates the conditions for the current emotional state index and selects a corresponding output row. For example, when the stress degree or the anxiety degree exceeds a high threshold and the motivation degree is below a medium threshold, the server sets the presentation mode to a simple mode, sets the presentation frequency to low, and sets the automatic control range to a semi-automatic mode. When the motivation degree is high and the stress degree is low, the server sets the presentation mode to a detailed mode, sets the presentation frequency to high, and sets the automatic control range to an automatic mode with pre-defined safety limits. The server stores the control policy as a record including these parameters.

The server generates a prompt sentence for a generative AI model on the basis of the observation information, the growth history information, the external provision information, and the emotional state index. The server first computes summary statistics of sensor values and growth history values using a numerical computation library. The server, for example, computes average soil moisture, maximum and minimum temperatures, cumulative rainfall over selected periods, and deviations from historical averages. The server converts these numeric values into human-readable phrases. The server selects a template for a prompt sentence according to the control policy and emotional state index. For a simple mode and high stress or high anxiety, the server selects a template that requests a small number of tasks with simple explanations and that instructs the generative AI model to avoid difficult technical terms. For a detailed mode and high motivation, the server selects a template that requests multiple alternative strategies and detailed reasoning.

In one example of a prompt sentence for a highly stressed user responsible for rice cultivation, the server generates:

“You are a Japanese agricultural support assistant.

Here is the current state of a rice field.
Crop: rice
Average sensor data for the last 7 days: average soil moisture 20%, air temperature 30° C., rainfall 2 mm
Current sensor readings: soil moisture 17%, pH 6.2, soil temperature 22° C.
Emotional state: the user has high stress and feels anxious.

For this user,
1. Propose only up to three tasks that must be done today, in bullet points.
2. Explain each task in one simple sentence.
3. Avoid difficult technical terms as much as possible.
4. Add one short sentence at the end to reassure the user.”

In another example of a prompt sentence for a highly motivated user managing a tomato field, the server generates:

“You are a professional advisor in Japanese smart agriculture.

The following is detailed data for a tomato field managed by a farmer.
Summary of the last 5 years: yield, fertilizer amounts, irrigation patterns, disease outbreak history
This season's sensor statistics (temperature, humidity, soil moisture, pH)
Weather forecast for next month (trend: high temperature, low rainfall)
Market demand data (tomato price is rising)
Emotional state: the user has high motivation and curiosity for learning.

For the next one month,
(1) Propose an irrigation, fertilization, and temperature control strategy aiming to maximize yield.
(2) Propose a conservative strategy that reduces disease risk and high-temperature risk.
(3) Propose a realistic strategy that balances (1) and (2).

For each strategy, describe:
The expected range of yield.
The main anticipated risks.
The agronomic rationale and past case examples (brief citations).”

The server inputs the prompt sentence into a generative AI model deployed on a hardware accelerator such as a graphics processing unit. The generative AI model is, in one embodiment, a transformer-based language model having multiple self-attention layers, each with multiple attention heads, and feed-forward sub-layers. The model was pre-trained on a large corpus of text and optionally fine-tuned on domain-specific agricultural documents and conversational data. The server uses a tokenizer to convert the prompt sentence into token identifiers, feeds the identifiers into the generative AI model, and obtains output token identifiers that correspond to generated natural language text. The server applies decoding algorithms such as greedy decoding, beam search, or nucleus sampling with configured parameters for maximum length and randomness.

The server interprets the generated text as agricultural work proposal information. The server may apply validation steps to ensure that the generated text conforms to requested constraints, such as limiting the number of bullet points or staying within a particular language. The server stores the generated agricultural work proposal information in a database with a link to the originating prompt sentence, the field identifier, and the user identifier. By structuring the generation in this way, the server uses the emotional state index as an input variable that modifies the internal operation of the generative AI model via the prompt sentence, resulting in outputs that are more likely to be accepted and understood by the user, thereby reducing the need for repeated queries and reprocessing.

The server analyzes the generated agricultural work proposal information to extract numerical parameter information required for controlling agricultural machinery. The server uses rule-based parsers and regular expressions to locate expressions that specify operation types and quantitative values, such as “irrigate 5 mm this evening,” “apply 30 kg of fertilizer per hectare,” or “spray once tomorrow morning on plot A.” The server maps qualitative expressions such as “light irrigation” to predefined numeric ranges using lookup tables stored in a configuration database. The server converts extracted values into device-specific units and formats, such as pump duty cycle and duration for an irrigation device or volume-per-area parameters for a spraying device. The server verifies that these numeric parameters lie within safety ranges stored in the control policy or device capability tables and normalizes them if necessary.

When the automatic control range in the control policy specifies an automatic mode for a particular operation type, the server constructs control command information as structured messages for the corresponding agricultural machinery and transmits the messages immediately via a communication path. The communication path may include a local area network, a wide area network, or a field bus, and may use protocols such as message-oriented protocols or device-specific control protocols. When the automatic control range specifies a semi-automatic mode, the server sends a control command candidate along with the relevant portions of the agricultural work proposal information to the terminal and sets a status indicating that user approval is required.

The terminal presents the agricultural work proposal information and, if applicable, the control command candidate to the user in a presentation mode determined by the control policy. In a simple mode, the terminal displays a small set of key tasks with short explanations and hides details behind user-operable controls. In a detailed mode, the terminal displays full text, historical charts, and comparative tables. The terminal provides input controls such as buttons for acceptance, rejection, and modification, sliders for adjusting numeric parameters, and input fields for comments. The terminal transmits user responses back to the server. In the semi-automatic mode, the server waits until the terminal sends approval operation information, then generates and transmits the final control command information to the agricultural machinery. In this way, the user retains an appropriate level of control when stress or anxiety is high, which improves safety and trust.

The described architecture improves computer technology in several ways. First, the server reduces computational and communication load by dynamically adjusting presentation frequency and detail level based on the emotional state index. For users with high stress or high anxiety, the server generates shorter prompt sentences and expects shorter outputs from the generative AI model, which reduces the number of generated tokens and inference time.

This also reduces the amount of data transmitted to the terminal. For highly motivated users, the server allows more detailed generation but can schedule such processing less frequently or in batch form. Second, the server uses the emotional state index to modulate prompt sentence content and structure, resulting in generated text that is more likely to be appropriate in length, complexity, and style. This reduces the need for the user to request clarifications or corrections, thereby decreasing the number of server-terminal interactions and associated processing. Third, by structuring the pipeline from feature extraction, emotion estimation, and prompt sentence generation to machine-control command synthesis, the server achieves a deterministic mapping from heterogeneous digital signals to both human-understandable information and physical control actions. This deterministic mapping, with explicit safety bounds and control modes, reduces error rates and improves robustness compared with ad hoc manual control or non-state-aware automation.

Additionally, the use of a trained neural network for emotion estimation enables the server to utilize complex correlations between user interaction patterns, linguistic content, and acoustic cues that are difficult for humans to infer consistently. The server therefore achieves higher accuracy and stability in detecting when to limit automation or when to present more supportive explanations. By integrating this emotional state information directly into the internal prompt sentence generation and control policy logic, the server changes not only the user interface but also the computational behavior of the underlying generative AI model and control-command generation algorithms. This is more than a mere automation of human decision-making processes; it is an improvement in the way the computer system manages resources and transforms inputs to outputs.

In alternative embodiments, the server may employ different types of generative AI models, such as encoder-decoder transformers or sequence-to-sequence recurrent networks, and may use different architectures for the emotion estimation model, such as convolutional networks for audio feature processing or recurrent networks for modeling temporal sequences of operations. The server may store features and models in different data structures, such as key-value stores or in-memory caches, to optimize latency. The control policy may be partially learned by reinforcement learning, wherein the server observes user acceptance rates and modifies thresholds or rule weights accordingly.

The system is not limited to a particular agricultural environment. The detection devices may include additional sensors such as imaging devices that capture multispectral images of crops, and the server may compute plant indices from such images. The agricultural machinery may include autonomous vehicles or robotic arms. The same architecture can be applied with minor adaptations to other physical control domains where user emotional state influences the required degree of automation and explanation complexity. However, in all embodiments, the core functionality remains that the server acquires digital signals, computes an emotional state index, generates an emotion-adaptive prompt sentence for a generative AI model, receives generated text, derives control command information, and transmits the command information to physical machinery, with the terminal mediating user interaction and approval where applicable.

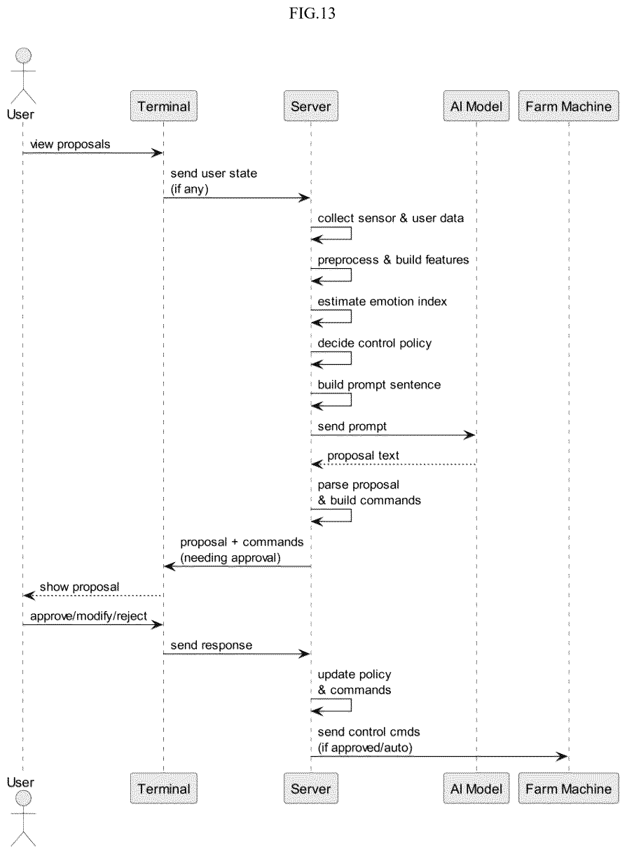

The following describes the processing flow using FIG. 13.

### Step 1

Server acquires and normalizes raw data.

Server receives, as input, observation information from detection devices (for example, soil sensors, weather sensors, imaging devices, pest detectors) and user-related data from terminals (operation history information, text information, and voice information). Server uses a web framework and a network interface to accept messages in formats such as JSON or binary, parses the payloads, attaches identifiers (sensor ID, field ID, user ID) and timestamps, and validates mandatory fields. Server converts the raw records into an internal normalized structure, for example, a row vector with fixed columns for each data type. Server outputs normalized observation records and normalized user-interaction records and writes them into short-term buffers or message queues for further processing.

### Step 2

Server performs preprocessing and feature preparation for environmental and historical data. Server receives, as input, normalized observation records, growth history records, and external provision information (forecast information and demand information) from data stores. Server uses a numerical computation library to sort records by time, resample them to uniform time intervals, and perform data cleaning such as outlier removal and interpolation of missing values. Server computes derived values such as moving averages of soil moisture, cumulative rainfall, and deviations from historical means. Server outputs cleaned time-series arrays and summary statistics, and stores them in a relational database as environmental feature tables that will later be referenced for prompt sentence construction and control decision-making.

### Step 3

Server aggregates operation history and generates behavioral feature information. Server receives, as input, operation history information from terminals, including screen identifiers, operation types, timestamps, and screen residence times. Server groups these records by user and by time window (for example, last 30 minutes, last day) using a data-frame processing library. Server calculates, for each user and time window, counts of operations, counts of cancellation operations, counts of help or info requests, and statistics of screen residence time (mean, maximum, variance). Server outputs behavioral feature vectors, each representing a set of numeric values per user, and stores them in a user-feature table.

### Step 4

Server processes text information and generates text-based emotional feature information. Server receives, as input, user text information (such as comments, questions, or feedback) associated with user identifiers and timestamps. Server applies a tokenizer from a natural language processing library to split the text into tokens or subword units and encodes the tokens as numeric IDs. Server feeds the token IDs into a pre-trained language model (for example, a transformer encoder) using a deep learning framework and computes a fixed-length text embedding, for example, by taking the vector of a special classification token or averaging token vectors. Server outputs text embedding vectors linked to user identifiers and stores them in a feature store for later integration with behavioral and acoustic features.

### Step 5

Server processes voice information and generates acoustic emotional feature information. Server receives, as input, user voice information files or streams and associated metadata (user identifiers, timestamps). Server loads each voice file and uses an audio processing library to perform pre-processing such as resampling, noise reduction, and segmentation. Server computes acoustic features such as Mel-frequency cepstral coefficients and their temporal statistics (mean, variance, delta coefficients) over the time axis. Server outputs acoustic feature vectors per voice sample, associates them with user identifiers, and stores them in a feature store alongside text and behavioral features.

### Step 6

Server integrates features and estimates the emotional state index.

Server receives, as input, behavioral feature vectors, text embedding vectors, and acoustic feature vectors for each user within a recent time horizon. Server aligns these feature sets by user identifier and time and concatenates them into a unified feature vector per user. Server loads a trained neural network model (for example, a multilayer perceptron with hidden layers and nonlinear activations) from storage into memory. Server supplies each unified feature vector to the model and performs forward propagation to compute raw scores for stress degree, fatigue degree, anxiety degree, and motivation degree. Server normalizes or otherwise scales the scores into a defined range and outputs an emotional state index vector per user, which it stores in a user-emotion table with a last-updated timestamp.

### Step 7

Server determines a control policy based on the emotional state index.

Server receives, as input, the emotional state index for a current user and, optionally, contextual information such as operation type or time of day. Server compares the emotional state index components with predefined thresholds stored in a rule table. For example, server checks whether the stress degree or anxiety degree exceeds high thresholds and whether the motivation degree is above or below a medium threshold. Based on these comparisons, server selects values for presentation mode (simple or detailed), presentation frequency (low, medium, high), and automatic control range (automatic, semi-automatic, manual). Server outputs a control policy object containing these parameters and stores it in a policy table, and may send a notification to the terminal to indicate a mode change.

### Step 8

Server summarizes agricultural state for recommendation generation.

Server receives, as input, cleaned environmental feature tables, growth history information, and external provision information for a specific field managed by a specific user. Server uses numerical operations to compute summary statistics for a predefined period (for example, last 7 days or last month), such as average soil moisture, temperature ranges, rainfall accumulation, and forecast trends. Server also computes economic indicators from demand information, such as average market price and trend direction. Server outputs a structured field-state summary and stores or caches this summary as a separate data structure that will be consumed during prompt sentence generation.

### Step 9

Server constructs an emotion-adaptive prompt sentence for the generative AI model. Server receives, as input, the field-state summary, growth history summary, external provision information, the emotional state index, and the control policy object. Server selects a prompt template according to the presentation mode and the emotional state index. For a high-stress user in a simple mode, server selects a template requesting few tasks with simple explanations and an explicit reassurance message; for a high-motivation user in a detailed mode, server selects a template requesting multiple strategies and detailed justifications. Server fills template placeholders with actual values from the summaries, such as crop type, average soil moisture, forecast traits, and emotional-states descriptions. Server transforms numerical values into human-readable phrases and inserts instructions about the desired output structure.

Server outputs a complete prompt sentence in natural language that describes the current conditions, user state, and requested output format.

### Step 10

Server invokes the generative AI model and generates agricultural work proposal information. Server receives, as input, the prompt sentence generated in Step 9. Server uses a tokenizer of the generative AI stack to convert the prompt sentence into a sequence of token identifiers and constructs an input tensor for the generative AI model. Server invokes the generative AI model, which is a transformer-based language model stored in memory and executed on a processor or accelerator, and configures decoding parameters such as maximum number of tokens to generate, sampling temperature, and top-k or top-p values. Server runs inference to generate an output token sequence and decodes the sequence back into a natural language string using the tokenizer. Server outputs agricultural work proposal information as the generated text, which includes recommended tasks, timing, quantities, rationales, and optionally reassurance or multi-strategy analysis, and stores this text in association with the originating prompt and user.

### Step 11

Server analyzes generated text and extracts control parameters.

Server receives, as input, the agricultural work proposal information in natural language form, together with the control policy. Server applies rule-based parsers and regular expression patterns to the text to detect phrases that specify quantitative parameters and targets, such as “irrigate 5 mm this evening,” “apply fertilizer at 30 kilograms per hectare,” or “spray once tomorrow morning on the north field.” Server converts qualitative descriptors (“light irrigation,” “moderate spraying”) into quantitative values via lookup tables, and resolves relative times (“this evening”) into absolute timestamps using system time and locale rules. Server computes normalized parameter values (for example, volumes per unit area, start times, durations) and checks them against safety ranges defined in device and policy tables, adjusting values if they exceed maximums or fall below minimums. Server outputs a structured set of control parameters ready for command construction.

### Step 12

Server constructs and dispatches control command information in accordance with the control policy.

Server receives, as input, the control parameters extracted in Step 11 and the control policy specifying the automatic control range. Server maps the normalized parameters to device-specific command formats for agricultural machinery such as irrigation controllers, application devices, spraying devices, and harvesting devices. Server composes messages or data packets that include identifiers of target devices, operation types, parameter values, and execution schedules. If the automatic control range for the operation is in the automatic mode, server transmits the control command information immediately to the respective devices via communication interfaces and logs the transmission. If the automatic control range is in the semi-automatic mode, server does not send the commands to machinery directly but instead creates control command candidates and outputs them, along with a summary of intended actions, to the terminal for user approval.

### Step 13

Terminal presents agricultural work proposal information and control command candidates. Terminal receives, as input, agricultural work proposal information, the control policy (including presentation mode and frequency), and, when applicable, control command candidates from the server. Terminal interprets the presentation mode field to choose an appropriate user interface layout. In a simple mode, terminal parses the proposal text to extract headlines and short explanations and displays them as large, easy-to-read items, with optional “show details” buttons for expanded text. In a detailed mode, terminal shows complete proposal text, graphs or charts derived from historical data, and comparisons of multiple strategies. When control command candidates are received, terminal displays summary cards describing the pending operations (for example, “Irrigate field A at 18:00 for 30 minutes”) and presents buttons for approval, modification, or rejection. Terminal outputs rendered user interface screens and makes interaction elements available for user actions.

### Step 14

User reviews proposals and issues responses via the terminal.

User receives, as input, visual content on the terminal display showing agricultural work proposal information and, when applicable, control command candidates. User examines the information, optionally expands details, and decides whether to accept, modify, or reject the suggested operations. User taps buttons such as “Execute as proposed,” “Modify,” or “Do not execute” and, in a modification case, uses sliders, numeric input fields, or selectors to adjust quantities and times. User may also type text comments expressing concerns or preferences, or press a microphone button to record a voice message. User thus outputs decision information and commentary to the terminal in the form of input actions and optionally new text or voice data.

### Step 15

Terminal records user operations and transmits them to the server.

Terminal receives, as input, user actions on the user interface, such as button presses, slider movements, text entries, and voice recordings. Terminal timestamps these actions, assigns a user identifier and device identifier retrieved from local storage, and creates operation history records describing the actions, including screen identifiers and operation types. Terminal packages modification contents (for example, updated irrigation amounts and times) and any text or voice comments as structured data. Terminal outputs a combined payload including operation history information, updated control parameters, and new text or voice information and sends it securely to the server via a communication channel, thereby providing new input for the server's subsequent rounds of feature extraction, emotion estimation, prompt sentence generation, and control policy adjustment.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional agricultural management systems typically process only physical environment data, such as soil moisture, temperature, and weather conditions, to generate recommendations for irrigation, chemical application, or harvesting. In such systems, a server generally collects sensor readings from a plurality of devices, executes relatively simple rule-based or statistical algorithms, and then issues control commands to agricultural machinery. These systems do not treat operator feedback and emotional responses as structured data, and thus cannot systematically incorporate such feedback into automated control logic. As a result, even if physical indicators such as yield, resource efficiency, or disease suppression improve, operators may still experience persistent dissatisfaction, anxiety, or distrust regarding the system's behavior, user interface, or timing of interventions. This leads to low acceptance of automated control, frequent manual overrides, and the need for burdensome tuning by human experts.

In addition, conventional systems that integrate a machine learning model typically treat the model as a one-directional prediction engine: the server feeds physical sensor data into a model and obtains an output such as a predicted yield or a binary disease risk. The internal behavior of the model remains opaque to the operator, and the server does not dynamically adapt its decision logic or communications based on how operators react over time. In particular, known systems do not construct structured “prompt sentences” that jointly encode current physical conditions and operator emotion indices as inputs to a generative AI model, and therefore cannot generate both machine control plans and operator-facing explanatory messages in a coordinated manner. The absence of such integrated prompt design results in generic or poorly targeted outputs that neither optimize physical performance nor improve operator understanding and comfort.

Furthermore, existing architectures often treat feedback from terminals as simple configuration inputs or troubleshooting messages, without any systematic emotion analysis. Although natural language comments and ratings may be collected, they are usually stored in log files or unstructured databases and read manually, if at all. The server does not apply natural language processing or other machine learning models to quantify emotional states, does not aggregate such indices per area and time window, and does not correlate them with sensor-based physical states. Therefore, the computing system cannot close the loop between its own control actions, the resulting physical states in the agricultural environment, and the evolving emotional responses of operators. This leads to a static or brittle control policy that must be re-designed by human experts and hinders continuous, data-driven improvement of the underlying computer-implemented control logic.

Moreover, even when a generative AI model is used in a separate context, it is commonly invoked with ad-hoc textual prompts crafted by a human operator. Such manual prompting is inefficient, non-repeatable, and difficult to validate, and it does not leverage the full richness of structured physical and emotional data available in a smart agriculture environment. In particular, conventional systems do not automatically build prompts that encode thresholds, constraints, and context regarding previous control cycles, nor do they automatically update prompts to reflect measured changes in both physical environment indicators and emotion indices. As a result, the generative AI model operates as a loosely coupled component, and the overall computer system does not realize the potential of closed-loop, machine-driven prompt generation and evaluation.

Accordingly, there is a need for a computer-implemented agricultural management system that technically improves server-side processing by: (i) acquiring and aggregating both physical environment data and operator emotion data as first-class structured signals; (ii) calculating integrated states that represent physical and emotional conditions in a unified data model; (iii) automatically generating structured prompt sentences for a generative AI model based on those integrated states and predefined constraints; (iv) converting the generative AI model's outputs into executable control plans and operator-facing messages; and (v) feeding back measured changes in both physical and emotional indicators into subsequent prompt generation. Such a system should improve the efficiency, adaptability, and robustness of the underlying computing architecture itself, rather than merely automating human decision-making, by creating a closed-loop, machine-driven workflow that continuously refines both control logic and communication content.

The specific processing by the specific processing unit 290 of the data processing device 12 in Application Example 2 is realized by the following means.

The present invention provides a server comprising a processor and a memory storing instructions that, when executed by the processor, cause the processor to acquire physical environment data from a plurality of detection devices arranged in an agricultural environment, the physical environment data including at least one of soil-related data, plant-related data, and surrounding environment-related data; receive, from an information processing terminal, evaluation information and natural language text information input by an operator or another stakeholder, apply at least one of a natural language processing model and another machine learning model to the evaluation information and the natural language text information to calculate an emotion index representing an emotional state of the operator or the other stakeholder, and aggregate the emotion index on an area basis and on a time basis; associate and aggregate the physical environment data and the emotion index on the area basis and on the time basis and calculate an integrated state that simultaneously represents a physical state and an emotional state in the agricultural environment; generate, based on the integrated state, a prompt sentence to be input to a generative AI model, the prompt sentence including at least a numerical indicator derived from the physical environment data, a numerical indicator derived from the emotion index, and at least one constraint related to control of an agricultural infrastructure and at least one condition for not deteriorating the emotional state of the operator or the other stakeholder; input the prompt sentence to the generative AI model and acquire, from the generative AI model, an output including a control plan for at least one of an agricultural machine and an agricultural infrastructure and information providing content to be presented to the operator or the other stakeholder; convert the control plan into at least one control command, transmit the at least one control command to at least one agricultural control device, and cause the at least one agricultural control device to operate in accordance with the at least one control command; transmit the information providing content to the information processing terminal and cause the information processing terminal to display or notify the information providing content; and evaluate changes between the emotion index and the physical environment data acquired after execution of the control plan and the information providing content and the emotion index and the physical environment data acquired before the execution, and reflect an evaluation result in a subsequent prompt sentence such that the prompt sentence for the generative AI model is updated based on the evaluated changes. This enables the server-side computing architecture to implement a closed-loop control and communication framework in which integrated physical and emotional data are continuously transformed into structured prompt sentences for a generative AI model, the generative AI model's outputs are automatically converted into device-level control commands and operator-facing messages, and measured effects on both physical indicators and emotion indices are fed back to iteratively improve the control logic and information content, thereby enhancing the technical performance, adaptability, and robustness of the computer-implemented agricultural management system.

The term “physical environment data” refers to data indicating a physical condition of an agricultural environment, the data including at least one of soil-related data, plant-related data, and surrounding environment-related data measured by a detection device.

The term “detection device” refers to a hardware device configured to measure at least one physical quantity in an agricultural environment, including at least one of soil moisture, soil chemical property, temperature, humidity, light intensity, plant growth status, and weather-related conditions, and to output the measurement result as digital data.

The term “information processing terminal” refers to an electronic device operated by an operator or another stakeholder, the electronic device including at least one of a mobile terminal and a stationary terminal and being configured to display information, receive user input including evaluation information and natural language text information, and communicate the user input to a server.

The term “evaluation information” refers to structured information representing a subjective assessment by an operator or another stakeholder, the structured information including at least one of a numerical rating, a category selection, and a score indicating satisfaction, safety, workload, trust, or another subjective perception.

The term “natural language text information” refers to text data composed of words, phrases, or sentences in a human natural language, the text data being input by an operator or another stakeholder and including at least one of comments, complaints, opinions, impressions, and requests related to an agricultural environment or a system operation.

The term “emotion index” refers to a numerical or categorical indicator representing at least one aspect of an emotional state of an operator or another stakeholder, the indicator being calculated by applying at least one of a natural language processing model and another machine learning model to evaluation information and natural language text information and being aggregatable on an area basis and on a time basis.

The term “natural language processing model” refers to a machine learning model configured to process natural language text information, including at least one of a classification model, a regression model, and a sequence model, and to output at least one of probabilities, scores, and labels corresponding to emotional categories or other semantic attributes.

The term “machine learning model” refers to a computational model trained on example data to infer a mapping between an input and an output, including at least one of a neural network, a decision tree ensemble, and a probabilistic model, and being executable by a processor to generate predictions, scores, or classifications from new data.

The term “area basis” refers to a classification or grouping of data according to a spatial unit in an agricultural environment, the spatial unit including at least one of a field, a plot, a zone, a greenhouse section, and another logical or physical sub-region identified by an area identifier.

The term “time basis” refers to a classification or grouping of data according to a temporal unit, the temporal unit including at least one of a time instant, a time interval, a time window, and a time period identified by at least one of a timestamp and a range of timestamps.

The term “integrated state” refers to a data structure or state quantity that combines at least one physical indicator derived from physical environment data and at least one emotional indicator derived from an emotion index for a same area and a same time basis, and that simultaneously represents a physical state and an emotional state in an agricultural environment.

The term “prompt sentence” refers to a sequence of natural language expressions provided as an input to a generative AI model, the sequence including at least one physical indicator, at least one emotion indicator, at least one control constraint, at least one communication constraint, contextual information, and a specification of a desired output format.

The term “generative AI model” refers to a machine learning model configured to generate content, including at least natural language text, based on an input prompt sentence, the model including at least a large language model or another generative model that outputs text representing a control plan and information providing content.

The term “control plan” refers to structured information representing a plan for controlling at least one of an agricultural machine and an agricultural infrastructure, the structured information specifying at least one of a timing, a target device, a control parameter, and a control action to be executed in an agricultural environment.

The term “agricultural infrastructure” refers to a collection of physical systems installed in an agricultural environment for managing at least one of water, nutrients, environment, and logistics, including at least one of an irrigation system, a chemical distribution system, a climate control system, a lighting system, and a harvesting assistance system.

The term “agricultural control device” refers to a hardware device configured to execute a control action in response to a control command in an agricultural environment, the hardware device including at least one of an irrigation device, a chemical supplying device, a harvesting device, and an environmental control device.

The term “information providing content” refers to information generated for presentation to an operator or another stakeholder, the information including at least one of guidance, a warning, a situation explanation, and a presentation of an alternative related to an agricultural environment, a work load, and a control content executed by a system.

The term “control command” refers to a machine-readable instruction transmitted from a server to an agricultural control device, the instruction specifying at least one of an operation mode, an operation timing, an operation intensity, and a target setting for the agricultural control device.

The term “operator” refers to a human user who interacts with an information processing terminal and an agricultural environment, the human user including at least one of a farmer, a technician, and a manager who monitors, configures, or evaluates a system.

The term “stakeholder” refers to a person other than an operator who is affected by or interested in an agricultural environment or a system, including at least one of a supervisor, a collaborator, a field worker, and a decision maker.

The term “evaluation result” refers to information derived from comparing at least one set of emotion indices and physical environment data acquired after an execution of a control plan and information providing content with at least one set of emotion indices and physical environment data acquired before the execution, the information indicating a change or trend used to update a subsequent prompt sentence.

The term “closed-loop control and communication framework” refers to a processing structure in which a server repeatedly performs acquisition of physical and emotional data, generation of an integrated state, automatic construction of a prompt sentence for a generative AI model, acquisition of generated outputs, execution of device-level control commands, delivery of information providing content, and feedback of evaluation results into subsequent prompt sentences.

In one embodiment, a server, a terminal, and a user cooperate to implement the present invention. The server is realized as a computing apparatus including at least one processor, a memory, a non-volatile storage device, and a network interface. The server executes an operating system, such as a general-purpose server operating system based on a UNIX-like kernel, and runs application software including a web application framework, a database management system, a message queue system, and a machine learning runtime. The terminal is realized as a mobile or stationary information processing device, such as a smartphone, a tablet, or a general-purpose computer, executing a mobile or desktop operating system. The user is an operator or another stakeholder engaged in agricultural activities and interacts with the terminal.

The server, in one concrete implementation, executes a web application framework (for example, a Python-based framework) on top of an HTTP server configured as a reverse proxy and an application server. The server manages structured data using a relational database management system, such as a general-purpose relational database engine. The server ingests time-series messages from detection devices via a distributed messaging infrastructure, such as a publish-subscribe message queue. The server executes machine learning models using a numerical computation framework, such as a tensor-based computing library, and a natural language processing library that provides tokenizers and pretrained models. The server optionally employs an image processing library to analyze image data and an audio signal processing library to analyze audio data. The server accesses a generative AI model by either hosting a large language model in the local environment using a machine learning framework or invoking an external API-based generative AI service via the network interface.

The terminal executes an operating system that provides graphical user interface components, a networking stack, and application sandboxes. The terminal runs an application dedicated to smart agricultural management. The terminal uses the operating system's location API to obtain position information, the operating system's audio API to record voice input, and optionally the operating system's camera API to capture still images or video frames. The terminal uses an HTTP client library to send structured data, including user feedback and sensor-related metadata, to the server and to receive server-generated information providing content.

The server acquires physical environment data from a plurality of detection devices arranged in an agricultural environment. The server receives, for example, soil moisture values, soil chemical condition values, ambient temperature and humidity values, illumination values, plant growth metrics, and local weather condition values. The detection devices may include soil probes, climate sensors, optical devices, and plant imaging devices. The server assigns each detection device to an area identifier and a sampling interval and stores the incoming measurements as rows in a time-series table in the relational database, with fields including a device identifier, an area identifier, a timestamp, and one or more measured values. The server uses index structures on the area identifier and timestamp columns to accelerate queries that group data by area and by time window.

The server receives evaluation information and natural language text information from the terminal. The terminal displays user interface components that allow the user to enter scores such as satisfaction level, perceived safety level, workload burden, and trust in the system, and allows the user to input natural language comments. The terminal uses the location API to determine the area identifier corresponding to the user's current plot, greenhouse compartment, or field, and packages the user input into a structured object including at least a user identifier, an area identifier, a timestamp, the numerical scores, and the free-form text. When the user activates voice feedback, the terminal records the audio, stores the audio file in local storage, and uploads the audio file together with the structured object to the server. The terminal uses Hypertext Transfer Protocol Secure to transmit the structured object and the audio file to the server's application programming interface.

The server parses the received data, validates required fields, and stores the evaluation information and the natural language text information in a feedback table of the relational database. If an audio file is provided, the server stores the audio file in an object storage service and registers a uniform resource locator in an audio reference field of the feedback table. The server then executes emotion analysis on the stored feedback. The server, for textual analysis, uses a natural language processing model such as a transformer-based neural network model. The server uses a tokenizer to convert the natural language text information into subword token identifiers and attention masks. The server feeds the token sequences into the transformer layers, each of which applies multi-head self-attention and linear projections followed by nonlinear activation functions and normalization layers. The server uses the output of a classification head attached to the transformer's pooled representation to compute logits for emotion categories such as anger, dissatisfaction, anxiety, relief, and satisfaction. The server applies a softmax function to the logits to generate emotion scores in the range from zero to one.

The server uses supervised learning to obtain the parameters of the natural language processing model. The server trains the model on a labeled corpus of agricultural or domain-specific comments, where each text sample is labeled with one or more emotion categories. The server defines a loss function such as a cross-entropy loss between the model's predicted probability distribution and the ground-truth labels, and uses a gradient-based optimization algorithm, such as an adaptive moment estimation method, to update the model parameters. During training, the server uses mini-batches of tokenized text, applies regularization techniques such as dropout on attention and feedforward layers, and may use data augmentation strategies such as synonym replacement or back-translation to improve generalization. After training, the server stores the model parameters in non-volatile storage and loads them into memory when performing inference.

The server, for audio analysis, downloads the audio file corresponding to a feedback record and uses an audio signal processing library to load and resample the waveform to a fixed sampling rate. The server computes a sequence of acoustic feature vectors, such as Mel-frequency cepstral coefficients and their first and second derivatives, over short time frames. The server feeds the feature vectors into a speech emotion recognition model implemented as a neural network, for example, a convolutional network followed by a recurrent network or a temporal convolutional network. The server defines an emotion classification head at the final layer and uses supervised learning with a cross-entropy loss and gradient descent to train the model on a labeled corpus of emotional speech. The server uses the trained model to compute probabilities for emotion labels such as anger, sadness, joy, and neutrality and stores the resulting emotion scores in an audio emotion table. The server may also perform visual emotion analysis if image data is available. The server loads an image, uses a computer vision library to detect a face region via a detector such as a histogram of oriented gradients-based detector or a deep convolutional detector, crops the face region, and feeds the cropped image into a convolutional neural network trained on facial expression datasets. The server obtains scores for expressions corresponding to emotional states and stores the scores in an image emotion table.

The server combines the textual, audio, and visual emotion indicators into a unified emotion index for each feedback record. The server may use a weighted averaging scheme or a small fusion network that accepts the text-based scores, audio-based scores, and image-based scores as input features and outputs a combined emotion vector. The server trains the fusion network using supervised labels and a loss function such as mean squared error or cross-entropy, depending on the label encoding. The server stores the unified emotion index in an emotion index table related to the original feedback record. By explicitly modeling the fusion process and storing the combined indices in structured form, the server improves the consistency and accuracy of emotion estimation compared to systems that treat each modality in isolation. The server aggregates the emotion indices on an area basis and a time basis. The server groups feedback records by area identifier and by discrete time windows, such as five-minute or fifteen-minute intervals, and computes statistics such as mean anger, mean dissatisfaction, mean anxiety, mean relief, and mean satisfaction scores for each area and time window. The server stores these aggregated values in an aggregated emotion table. In parallel, the server aggregates physical environment data by area identifier and time window, computing mean soil moisture, mean temperature, mean leaf wetness, cumulative irradiation, and other indicators. The server stores these aggregates in a physical state table.

The server calculates an integrated state by joining the aggregated emotion table and the physical state table on area identifier and time window. The server thus forms integrated state records that contain both physical indicators and emotion indicators for the same spatio-temporal unit. Each integrated state includes, for example, the mean soil moisture and the mean anger score of operators responsible for that plot during a specific interval. The server uses such integrated states as the basis for generating prompt sentences.

The server automatically selects target integrated states by applying non-trivial rules and thresholds. The server may, for example, identify integrated states where a physical indicator such as water stress, pest risk, or nutrient deficiency exceeds a predetermined threshold, and where an emotion indicator such as anger, dissatisfaction, or anxiety also exceeds a predetermined threshold. By performing this selection algorithm centrally and using indexed queries on the relational database, the server reduces the computational cost of scanning large volumes of raw data and localizes attention on problematic areas. This improves processing efficiency compared to naive rule-based systems that analyze each stream independently.

The server generates a prompt sentence for each selected integrated state. The server uses a template engine and a parameterization scheme in which placeholder tokens within a natural-language template are replaced with specific numeric values and contextual descriptors from the integrated state. The server includes in the prompt sentence at least: numeric physical indicators, numeric emotion indicators, constraints on agricultural infrastructure control, communication constraints designed to avoid deteriorating the operator's emotional state, and instructions describing the desired output format. By encoding the integrated state and constraints into a consistent, machine-generated prompt format, the server reduces variance in prompting, improves reproducibility of interactions with the generative AI model, and facilitates automatic post-processing of the generated output.

For example, the server may construct a prompt sentence as follows:

“You are a smart agriculture operations assistant. Based on the following data for Field A, propose in Japanese: (1) a detailed irrigation and pesticide application control plan for the next 2 hours, and (2) a calm and respectful message for the field operator that does not increase anger or anxiety.

### [Physical Data]

Average soil moisture in the last 30 minutes: 18%.
Average air temperature in the last 30 minutes: 32° C.
Disease risk indicator: high.

### [Emotion Data]

Anger score for the operator group: 0.75.
Dissatisfaction score for the operator group: 0.7.
Anxiety score for the operator group: 0.65.

### [Constraints]

Reduce the disease risk while avoiding excessive water usage.
Do not schedule irrigation during the operator's manually reserved time slots.
Use a polite and reassuring tone in the message.
Explain why the control plan is necessary, how long it will continue, and what benefits are expected.

### [Output Format]

Section 1: “Control plan”—list the operations as bullet points with time ranges and parameter values.
Section 2: “Message for operator”—provide one concise paragraph in Japanese.”

In another example, the server may construct a prompt sentence focusing on climate control:

“You are a greenhouse climate management assistant. Based on the following physical environment data and emotion indices for Greenhouse B, propose in Japanese: (1) a climate control plan for the next 4 hours (including ventilation and shading), and (2) an explanatory message for the greenhouse manager.

### [Physical Data]

Average internal temperature: 35° C.
Average humidity: 85%.
Light intensity: high.

### [Emotion Data]

Dissatisfaction score: 0.8.
Satisfaction score: 0.2.

### [Constraints]

Decrease internal temperature and humidity into recommended ranges.
Do not significantly increase power consumption beyond the current baseline.
Use clear, non-technical language in the message to improve understanding.

### [Output Format]

Section 1: “Climate control plan”.
Section 2: “Message for manager”.”

The server transmits the constructed prompt sentence to a generative AI model. If the model is hosted locally, the server uses a machine learning runtime to perform inference on a large language model architecture, such as a multi-layer transformer decoder with self-attention and cross-attention mechanisms. The server feeds the prompt tokens into the model and generates output tokens using decoding algorithms such as beam search, top-k sampling, or nucleus sampling, with parameters such as temperature and maximum output length configured according to system policy. If the model is provided as an external service, the server encapsulates the prompt sentence in a request payload and sends it to the service endpoint via the network interface, then receives a response containing the generated text.

The server parses the generated text according to the output format described in the prompt sentence. The server searches for section labels such as “Control plan” and “Message for operator” and splits the content accordingly. The server converts the control plan section from free text into a structured representation by applying parsing rules, regular expressions, or a secondary parsing model. For example, the server identifies time ranges, devices, and parameter values from phrases such as “from 18:00 to 19:00, irrigate Field A at 8 mm/h” and converts them into records specifying a start time, an end time, a device identifier, and a target parameter value. The server stores these records in a control plan table. The server stores the message section as text in a message template table linked to the relevant area identifiers and time windows.

The server uses the structured control plan to generate device-level control commands. The server translates high-level actions into device-specific instructions conforming to the communication protocols of the agricultural control devices. For irrigation, the server may generate commands specifying valve openings, pump activation, and flow rates and send them through a field network to irrigation controllers. For chemical application, the server may generate commands specifying application rate, start time, and target area and transmit them to dispensing equipment or autonomous vehicles. For climate control, the server may generate commands for ventilation, shading, fogging, or heating systems. By programmatically mapping the control plan to actual device commands, the server ensures that generative AI output produces physically meaningful and executable actions, and the system produces a tangible effect in the agricultural environment.

The server transmits the information providing content to the terminal associated with operators in the relevant areas. The server uses a notification mechanism, such as push notification services or in-app messaging protocols, to deliver messages that explain upcoming operations, their rationale, and expected effects. The terminal receives the messages and displays them in the application's user interface, optionally with graphical summaries such as schedules, charts, or simple icons. The user thus has contemporaneous access to both the physical changes being executed by the system and textual explanations adjusted according to the user's emotional state.

The server evaluates the effect of its control plans and messages by comparing the emotion indices and physical environment data before execution and after execution. After a control cycle and information delivery, the server acquires a new batch of sensor readings and new user feedback. The server computes updated emotion indices and updated aggregates and compares them with previous values. The server may compute differences, ratios, or more complex features such as moving averages and statistical significance indicators. The server uses these evaluation results to adjust selection thresholds for future integrated states, to update weights in the fusion models, or to modify the structure of prompt sentences. For example, if a particular explanation style consistently reduces anger scores while maintaining or improving yield, the server may adjust the template to emphasize such style across similar contexts. This constitutes an iterative improvement loop that modifies the internal computation and data flow of the server as more data are processed.

The system provides technical effects beyond mere automation of human decision-making. By representing physical environment data and emotion indices in a unified integrated state and by structuring prompt sentences based on that state, the server reduces the dimensionality and redundancy of input to the generative AI model, thereby decreasing computation time and memory usage. By automating the prompt construction, the server reduces variability and errors associated with manual prompt engineering and allows the generative AI model to operate with more stable, machine-verifiable input patterns. By using indexed relational tables and time-windowed aggregation, the server decreases the volume of data that must be transmitted or processed at each cycle compared to naive per-sample processing, leading to reduced network and processing load.

The server further improves accuracy by using multimodal emotion analysis, fusing textual, audio, and visual features through a learned fusion network that can capture interactions among modalities. This reduces misclassification compared to systems that rely solely on simple sentiment rules or single-modality indicators. The server's training procedures, including the choice of loss functions, optimization algorithms, and data augmentation techniques, contribute to higher robustness in the presence of noise or domain shift. By storing emotion indices and physical indicators in normalized, indexed tables and separating raw data from derived aggregates, the server improves data management, enabling efficient queries, historical analyses, and model retraining.

The terminal and the server cooperate to reduce communication overhead. The terminal performs local preprocessing, such as compressing audio files, encoding location into area identifiers, and packaging multiple user inputs into single requests. This reduces the size and frequency of transmitted data. The server, by aggregating data into integrated states, avoids broadcasting raw sensor data or unfiltered emotion indices to the generative AI model, again reducing the amount of data that must be handled by the model and the external service. The system uses processing rules and algorithmic flows that differ from conventional rule-based or manual workflows. Instead of a static set of decision rules, the server implements a non-conventional workflow in which (i) integrated states representing both physical and emotional conditions drive prompt sentence generation, (ii) prompt sentences encode both quantitative constraints and qualitative communication requirements, and (iii) evaluation results feed back into future prompt structure and threshold settings. The combination of integrated states and structured prompt generation results in a distinct technical architecture that modifies how the computing system processes data, rather than merely substituting human experts with automated recommendations.

Variations of the described embodiment are possible. In one alternative, the server uses a different neural network architecture, such as a recurrent-based encoder for natural language instead of a transformer-based model, or a graph neural network to represent relationships among fields and devices. In another alternative, the server trains a reinforcement learning agent that selects prompt templates or control plans based on rewards computed from changes in both physical and emotional indicators. In still another alternative, the server hosts multiple generative AI models specialized for different tasks, such as irrigation planning, disease management, or climate control, and selects among them or combines their outputs based on the integrated state.

In yet another embodiment, the server encrypts stored feedback and emotion indices to comply with privacy requirements, and uses homomorphic or secure computation techniques to perform certain aggregations without revealing raw data. In all embodiments, the underlying principle remains that the server acquires and aggregates physical and emotional data, computes integrated states, automatically generates prompt sentences for a generative AI model, converts the resulting text into concrete control commands and operator-facing messages, and evaluates subsequent changes to refine future computation. Through these computerized operations, the system improves the internal functioning of the computing architecture, enhances the efficiency and accuracy of device control in an agricultural environment, and achieves technical advantages in processing speed, robustness, and resource usage that are not obtained by conventional manual or rule-based approaches.

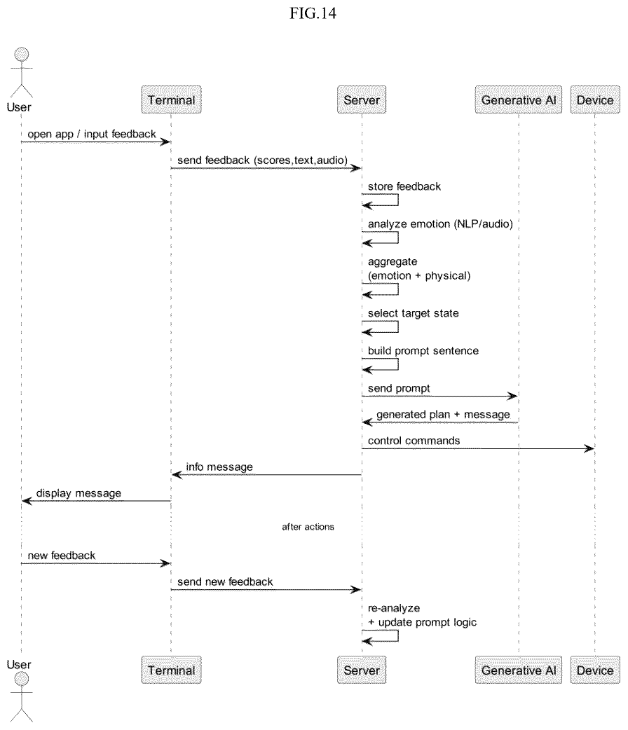

The following describes the processing flow using FIG. 14.

### Step 1

The user operates the terminal and launches a smart agriculture management application on the terminal. The user views a feedback screen that the terminal renders using the operating system's graphical user interface components, such as buttons, sliders, rating bars, and text input fields. The user inputs evaluation information, including numerical scores (for example, satisfaction, perceived safety, workload, or trust) and natural language text information, such as comments or complaints about field conditions, irrigation timing, or system behavior. The user optionally presses a voice feedback button, and the terminal uses an audio recording API to capture the user's speech and stores the recorded audio as a file in local storage.

Input: The user's interactions with the user interface (touch events or keyboard input).

Operation: The terminal converts the user interface events into numerical scores, text strings, and audio samples.

Output: The terminal holds in memory and local storage a set of feedback elements including scores, natural language text, and an audio file reference associated with the current user session.

### Step 2

The terminal uses the operating system's location API to acquire the current geographic coordinates of the terminal. The terminal matches the coordinates against preloaded or server-supplied geospatial data, such as a map of fields, zones, or greenhouse sections, to determine an area identifier representing the current agricultural location. The terminal associates the area identifier, a timestamp, and a user identifier or anonymous identifier with the feedback elements.

Input: Raw geographic coordinates from the location API and user feedback elements from Step 1.

Operation: The terminal performs a spatial lookup by comparing coordinates to region polygons or grid cells, then appends the resulting area identifier and the current time to the feedback data structure.

Output: The terminal creates an enriched feedback record containing user ID, area ID, timestamp, evaluation scores, text comment, and audio file reference.

### Step 3

The terminal formats the enriched feedback record into a structured data object. The terminal uses a JSON serialization library to encode the user ID, area ID, timestamp, numerical scores, and text comment as a JSON object, and, if audio is present, prepares a multipart/form-data payload that includes the JSON object and the audio file. The terminal then uses an HTTP client library to construct an HTTPS POST request addressed to a server endpoint dedicated to feedback reception.

Input: The enriched feedback record from Step 2.

Operation: The terminal maps in-memory fields to JSON keys, encodes them as a UTF-8 payload, and, if necessary, segments the payload into JSON and binary parts for multipart encoding.

Output: The terminal produces a network request containing a structured JSON body and optional audio file, ready to be sent over the network.

### Step 4

The terminal sends the HTTPS POST request to the server and waits for a response. The terminal transmits the request over the network interface and monitors for a status code and response body from the server. Upon receiving a successful response, the terminal stores an acknowledgment, such as a record identifier, in local storage. If the request fails due to network errors or non-successful status codes, the terminal stores the failed payload in a local retry queue for later retransmission.

Input: The fully constructed HTTP request from Step 3.

Operation: The terminal invokes the HTTP client's send function, handles connection setup, and processes the returned status code and body.

Output: The terminal obtains and stores either a success acknowledgment or a retry entry representing the pending feedback.

### Step 5

The server receives the HTTPS POST request from the terminal at a predefined application programming interface endpoint. The server uses the HTTP server and web application framework to parse the incoming request. The server decodes the JSON body, validates required fields, and, if an audio file is included, writes the audio file to object storage and records the corresponding storage locator. The server then inserts a new record into a feedback table within the relational database, including user ID, area ID, timestamp, scores, text, and the audio file locator if present.

Input: The HTTP request containing JSON feedback data and optional audio file from the terminal.

Operation: The server performs JSON deserialization, schema validation, optional file streaming to storage, and a database insert operation.

Output: The server creates a persistent feedback record in the database and a corresponding confirmation response sent back to the terminal.

### Step 6

The server retrieves newly stored feedback records that lack emotion analysis results. The server queries the feedback table for such records and fetches the associated natural language text information. The server uses a natural language processing library to tokenize the text into subword tokens and then executes a trained transformer-based classifier to calculate emotion scores, such as anger, dissatisfaction, anxiety, relief, and satisfaction. The server applies a softmax transformation to obtain normalized probabilities and stores the resulting emotion scores in an emotion analysis table linked to the original feedback record.

Input: Raw text comments associated with feedback records from the database.

Operation: The server applies text tokenization, forward passes through neural network layers, and probability normalization.

Output: The server generates numeric emotion indices per feedback record and writes them into a structured database table.

### Step 7

The server analyzes any audio feedback referenced by the feedback records. The server downloads or accesses the audio files via their storage locators and uses an audio processing library to load the waveform at a standardized sampling rate. The server computes short-time acoustic features, such as Mel-frequency cepstral coefficients, over overlapping time frames. The server then feeds these feature sequences into a trained speech emotion recognition neural network, which outputs probabilities for audio-based emotion categories such as anger, sadness, joy, and neutral. The server writes the resulting audio emotion scores into an audio emotion table linked to the feedback record.

Input: Audio file locators associated with feedback records and the corresponding audio content.

Operation: The server performs resampling, feature extraction, neural network inference, and probability calculation.

Output: The server generates audio-based emotion indices and stores them in a database table associated with each feedback record.

### Step 8

The server optionally performs visual emotion analysis when image or video data is available.

The server uses a computer vision library to load the image and detect one or more face regions using a face detection algorithm. The server crops face regions and feeds them into a trained convolutional neural network for facial expression recognition, which outputs scores for expressions such as happiness, anger, or fear. The server stores these visual emotion scores in an image emotion table linked to the feedback record.

Input: Image data and associated metadata if such data exists for a feedback record.

Operation: The server executes face detection, image cropping, convolutional feature extraction, and classification into expression categories.

Output: The server obtains visual emotion indices and persists them in structured form.

### Step 9

The server fuses the emotion indices obtained from text, audio, and image modalities into a unified emotion index. The server retrieves the emotion scores from the respective tables for each feedback record and constructs a feature vector containing the scores from all available modalities. The server applies either a predefined weighting scheme or a trained fusion model, such as a small feedforward neural network, to compute a combined emotion vector. The server uses this combined vector as the unified emotion index and stores it in an emotion index table tied to the feedback record.

Input: Text-based, audio-based, and optional image-based emotion scores for each feedback record.

Operation: The server concatenates multi-modal scores, applies weighted aggregation or neural network fusion, and calculates a combined emotion representation.

Output: The server generates a unified emotion index per feedback record and writes it into a dedicated database table.

### Step 10

The server aggregates the unified emotion indices across space and time. The server groups the emotion index records by area identifier and by discrete time windows, such as five-minute intervals. For each group, the server computes statistical measures including average anger, average dissatisfaction, average anxiety, average relief, and average satisfaction, as well as counts of feedback records. The server stores these aggregated emotion metrics in an aggregated emotion table indexed by area and time window.

Input: Unified emotion index records with area IDs and timestamps.

Operation: The server executes group-by queries or batch processing jobs to compute averages, counts, and other aggregate statistics.

Output: The server produces area- and time-based aggregated emotion metrics and stores them as new records.

### Step 11

The server continuously ingests physical environment data from detection devices deployed in the agricultural environment. The server receives sensor messages via a messaging system or direct network calls, each message including a device identifier, area identifier, timestamp, and one or more physical measurements. The server appends these records to a sensor data table. The server then aggregates the physical measurements by area and time window, computing values such as average soil moisture, average temperature, total irrigation volume, and disease risk indicators. The server stores the aggregated physical metrics in a physical state table keyed by area and time window.

Input: Raw sensor measurement messages from detection devices.

Operation: The server performs message parsing, database insertion, and aggregation computations over defined spatial and temporal groupings.

Output: The server creates area-based and time-based physical environment state records.

### Step 12

The server calculates integrated states by joining the aggregated emotion metrics and the physical state records. For each area and time window, the server retrieves the corresponding emotion metrics and physical metrics and combines them into a single integrated state record.

The server formats this record to contain well-defined fields, such as mean soil moisture, mean temperature, mean anger score, and mean dissatisfaction score, all aligned for the same spatio-temporal unit. The server stores the integrated state records in an integrated state table.

Input: Aggregated emotion metrics and aggregated physical environment metrics matched by area and time window.

Operation: The server performs database join operations and merges the matched fields into unified records.

Output: The server generates integrated state records representing combined physical and emotional conditions.

### Step 13

The server selects target integrated states that meet predefined criteria for further analysis and control generation. The server executes a selection query or algorithm that filters integrated states where certain physical indicators exceed thresholds, such as high disease risk or low soil moisture, and where certain emotion indicators, such as anger, dissatisfaction, or anxiety, also exceed thresholds. The server compiles a list of candidate areas and time windows where both technical conditions and operator emotions indicate the need for intervention.

Input: Integrated state records from the integrated state table.

Operation: The server applies threshold comparisons and logical conditions to filter the records.

Output: The server produces a subset of integrated state records representing target scenarios for control and communication.

### Step 14

The server generates a prompt sentence for each selected integrated state. The server uses a text template with placeholders for physical metrics, emotion metrics, constraints, and desired output format. The server fills in the placeholders with numeric values and contextual details from the integrated state record, such as average soil moisture, average temperature, anger score, and dissatisfaction score. The server also inserts constraints specific to the agricultural infrastructure, such as water use limits, timing restrictions, and communication constraints on tone and content. The server thus constructs a complete natural-language prompt sentence for each scenario.

Input: Selected integrated state records with physical and emotion indicators and stored constraint definitions.

Operation: The server applies string templating, unit formatting, and parameter substitution to generate final text.

Output: The server produces one or more prompt sentences in text form, each describing a scenario and the requested output from the generative AI model.

### Step 15

The server passes each generated prompt sentence to a generative AI model. If the model operates locally, the server tokenizes the prompt and feeds the token IDs into a large language model implemented as a transformer decoder, configuring decoding parameters such as maximum length, sampling strategy, and temperature. If the model is accessed via an external service, the server embeds the prompt in a request message and sends it to the remote endpoint. The server receives the generated text completion, which typically includes a control plan for agricultural devices and an operator-facing message.

Input: Prompt sentences produced in Step 14.

Operation: The server executes generative model inference locally or calls a remote service, converting natural-language prompts into generated text outputs.

Output: The server obtains generated responses containing a proposed control plan and information providing content.

### Step 16

The server parses the generated responses into structured components. The server identifies section boundaries in the generated text based on markers specified in the prompt, such as section headers like “Control plan” and “Message for operator.” The server extracts the control plan section and analyzes it to detect explicit time intervals, device actions, and parameter values using pattern matching, regular expressions, or a secondary parsing model.

The server converts the parsed actions into structured control plan entries with fields for area ID, device type, start time, end time, and control parameters. The server stores these entries in a control plan table. The server stores the operator-facing message section in a message template table associated with the relevant area ID and time frame.

Input: Generated response texts from the generative AI model.

Operation: The server performs text segmentation, structured parsing, and database insertion of plan and message components.

Output: The server creates machine-readable control plan records and corresponding human-readable message records.

### Step 17

The server transforms the structured control plans into device-level control commands. For each control plan entry, the server identifies the target agricultural control device or group of devices responsible for the specified area and function. The server maps high-level plan parameters, such as irrigation rate and duration, to protocol-level command fields required by the devices, such as address, command code, and data payload. The server then sends the control commands over the appropriate communication channel, such as a field bus or IP-based network, to the devices.

Input: Control plan entries from the control plan table.

Operation: The server applies device mapping rules, constructs protocol messages, and transmits them through the network interface.

Output: The server issues actionable control commands to devices, causing physical operations such as opening valves, activating pumps, or adjusting climate systems.

### Step 18

The server prepares and transmits operator-facing messages based on the message templates.

The server selects message records relevant to current or imminent control actions and identifies the operators associated with the corresponding areas using a user-to-area mapping table. The server constructs notification payloads containing the message text and optional metadata, such as related schedules or maps, and sends them to the terminals via push notification services or in-app messaging channels.

Input: Message templates from the message template table and operator-area mapping information.

Operation: The server formats notification content, resolves target terminals, and submits messages to notification services.

Output: The server delivers informational messages to terminals belonging to operators in affected areas.

### Step 19

The terminal receives the operator-facing messages and displays them to the user. The terminal obtains the notification payload from the operating system's notification framework or from an in-app messaging interface. The terminal opens the smart agriculture application and renders a screen showing the full message text, and optionally, visual aids such as charts of expected irrigation times, temperature profiles, or disease risk forecasts. The user reads the message, understands upcoming system actions, and observes corresponding environmental changes in the fields or greenhouses.

Input: Notification payloads and related data received from the server.

Operation: The terminal invokes application display logic and renders the received content on the screen.

Output: The terminal presents human-readable messages and associated visual context to the user.

### Step 20

The user experiences the physical changes in the agricultural environment and the explanatory messages presented by the terminal. The user evaluates whether the changes have improved conditions, reduced workload, or addressed prior concerns. The user then returns to the feedback screen on the terminal and provides new evaluation information and natural language text information, and optionally new audio feedback, describing the user's updated perceptions and emotional state.

Input: The user's observations of physical operations and system messages.

Operation: The user mentally assesses the situation and interacts with the terminal's user interface components to encode this assessment as new scores and comments.

Output: The user supplies updated feedback content, which the terminal captures as new feedback elements for subsequent transmission.

### Step 21

The terminal and the server repeat the above steps for the new feedback. The terminal packages the new scores, text, and audio with area identifiers and timestamps, sends them to the server, and the server performs emotion analysis, aggregation, integrated state computation, and evaluation of changes in physical and emotional indicators. The server compares the new aggregated metrics with prior values, computes differences or trends, and uses these evaluation results to update selection thresholds, fusion weights, and prompt sentence templates. Thus, the server modifies how it constructs prompt sentences and how it conditions the generative AI model to produce future control plans and messages.

Input: New feedback records and updated sensor data collected after one or more control cycles.

Operation: The server executes the same data processing pipeline, additional comparison calculations, and configuration updates based on measured changes.

Output: The server obtains evaluation results and refined prompt generation parameters, which influence subsequent prompt sentences and lead to iterative improvements in system behavior.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

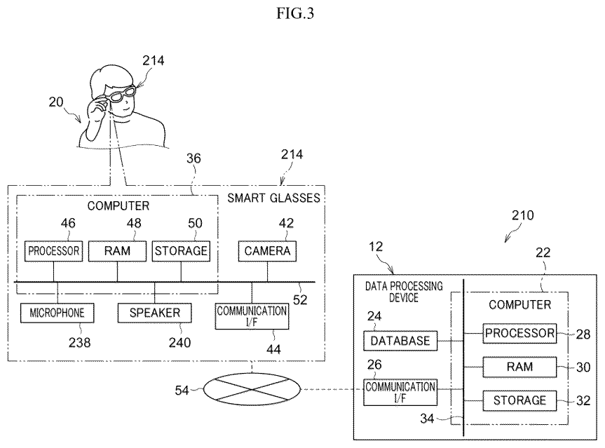

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

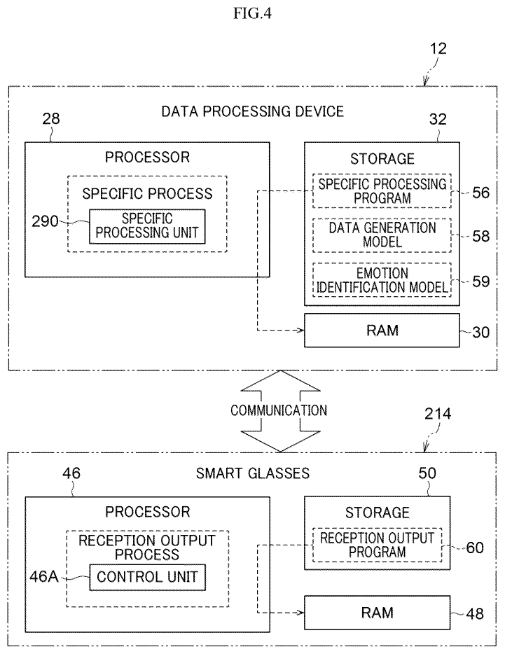

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

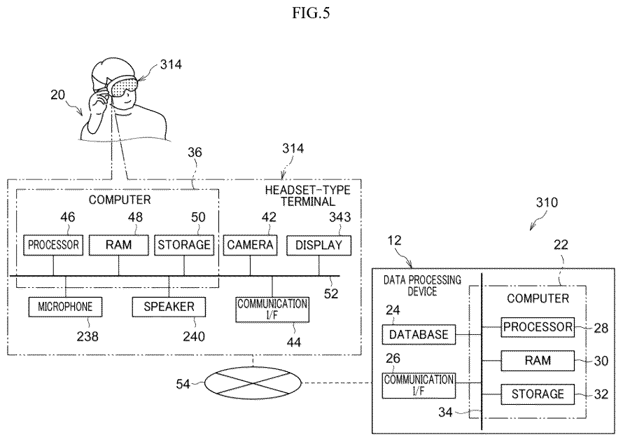

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

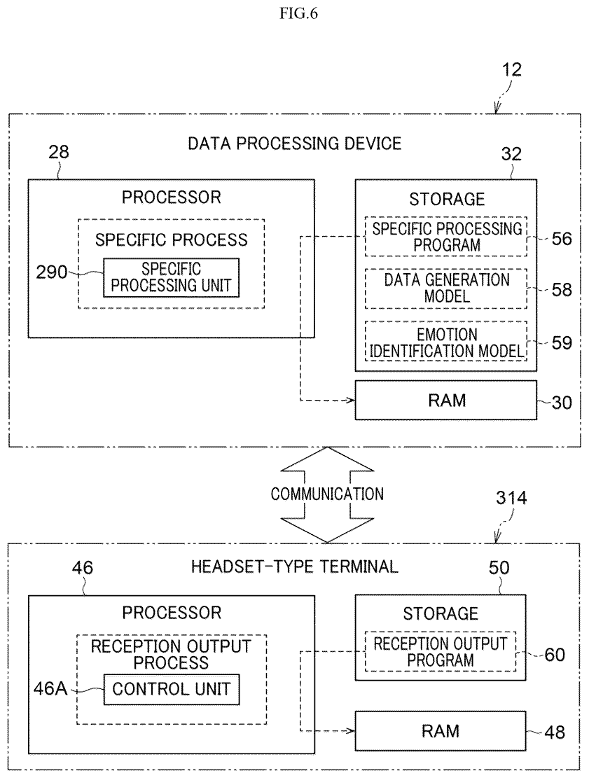

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

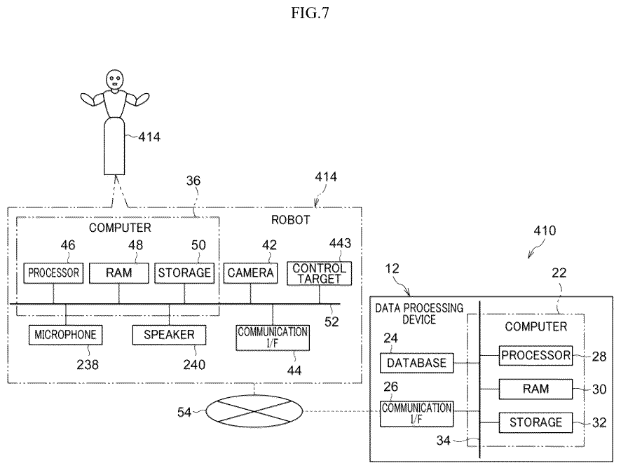

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

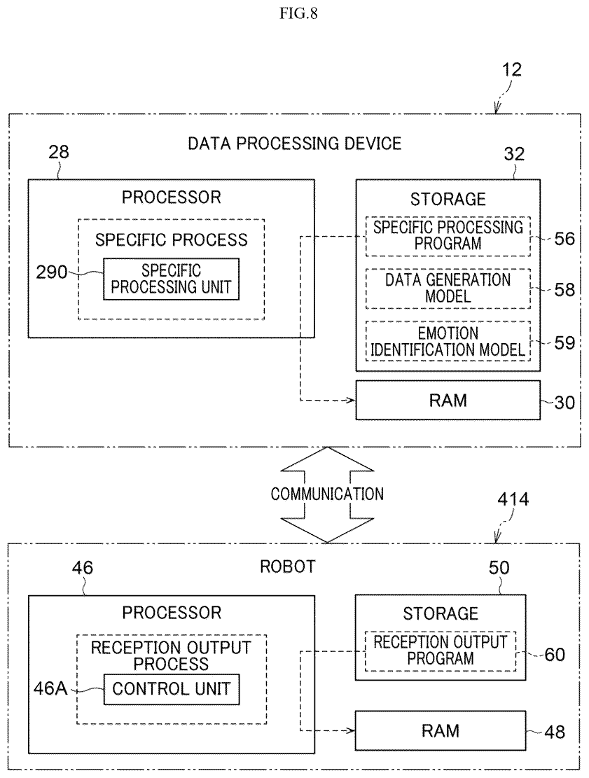

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

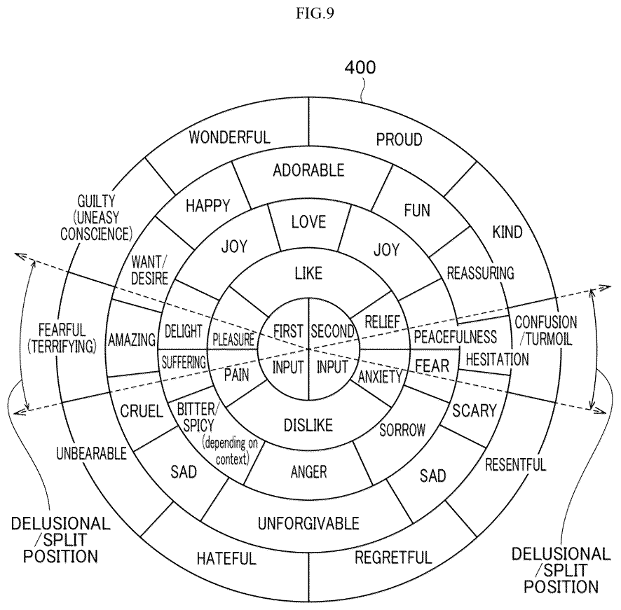

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

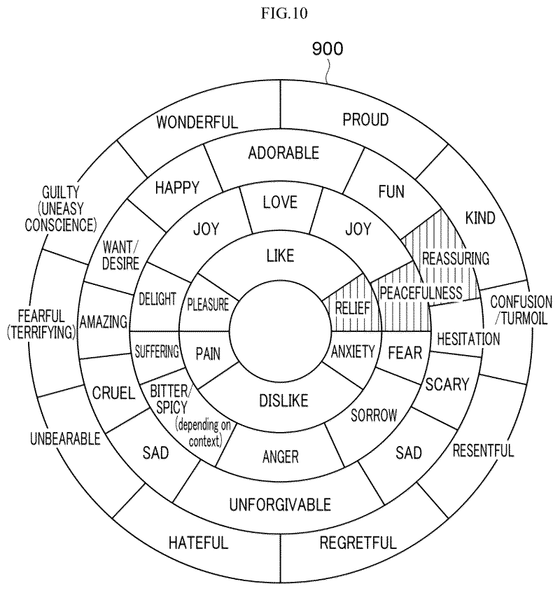

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to acquire environmental information and growth information from an information acquisition apparatus arranged in an agricultural facility,
wherein the processor is configured to perform numerical data preprocessing on the environmental information and the growth information, to generate feature data, and to execute prediction processing by using a machine learning algorithm based on the feature data and external information,
wherein the processor is configured to convert a prediction result of the machine learning algorithm and the external information into a natural language expression, to generate a prompt sentence including the natural language expression, and to input the prompt sentence to a generative artificial intelligence model so as to obtain a response sentence describing an agricultural work plan and a resource allocation policy,
wherein the processor is configured to extract control parameters for a work apparatus including at least one of an irrigation apparatus, a chemical spraying apparatus, and a harvesting apparatus from the response sentence, and to generate an operation plan of the work apparatus based on the control parameters,
wherein the processor is configured to generate and transmit a control signal for the work apparatus based on the operation plan,
wherein the processor is configured to cause a display and input interface to present at least one of the environmental information, the prediction result, the response sentence, and the operation plan, and to receive from a user at least one of an approval input, a modification input, and a cancellation input with respect to the operation plan, and
wherein the processor is configured to feed back the approval input, the modification input, and the cancellation input to an operation plan generation process and to a generative artificial intelligence processing process, and to generate the prompt sentence by adding preference information of the user and past intervention history of the user to the prompt sentence.

### Supplementary 2

The system according to supplementary 1,
wherein the processor is configured to add statistical information based on at least one of past yield information, quality information, weather information, and price information to the prompt sentence, and to cause the generative artificial intelligence model to generate a medium-to long-term agricultural management plan including at least one of a planting plan for a predetermined period, an input material quantity, a labor allocation, and a risk reduction measure.

### Supplementary 3

The system according to supplementary 1,
wherein the processor is configured to store evaluation information from the user and performance information of the work apparatus, to update learning data for the machine learning algorithm based on the evaluation information and the performance information, and to automatically add, to the prompt sentence, constraint conditions indicating at least one of an allowable loss amount of the user, an allowable chemical use amount, and a water use limitation amount.

### Application Example 1

### Supplementary 1

A system comprising a processor,
wherein the processor is configured to
receive observation information representing environmental states or operational states of a predetermined spatial region from a plurality of detection devices that measure physical quantities, and aggregate the observation information and calculate statistical information, input the statistical information as feature information into a machine learning algorithm and estimate a future state or a risk indicator of the predetermined spatial region,
generate, based on the statistical information and the estimated future state or the risk indicator, a prompt sentence in a natural language, the prompt sentence including at least a description of the statistical information and the estimated future state or the risk indicator,
generate request data including the prompt sentence, transmit the request data to a generative AI model, receive a response sentence in the natural language from the generative AI model, and parse the response sentence to convert the response sentence into structured information indicating a control policy or an operation plan for the predetermined spatial region,
generate, based on the structured information, control commands for actuators including at least one of a fluid transport apparatus, a lighting apparatus, an air conditioning apparatus, or a mobile body control apparatus, transmit the control commands to the actuators, and thereby change a physical state of the predetermined spatial region,
store the observation information, the statistical information, the prompt sentence, the response sentence, the control commands, and response information received from the actuators in a storage, and update at least one of the machine learning algorithm or generation rules for the prompt sentence based on the stored information, and
provide, to a terminal device, display information including the observation information, the estimated future state, the control policy, and an application status of the control commands,
receive, from the terminal device, intervention instruction information for approving,
rejecting, or modifying at least part of the control commands, and change applicability or content of the control commands based on the intervention instruction information.

### Supplementary 2

The system according to supplementary 1,
wherein the processor is configured to
automatically generate, as the prompt sentence to be transmitted to the generative AI model, an explanatory sentence including at least current statistical information, the estimated future state, constraint conditions regarding a control target, and an optimization objective, and, from the response sentence acquired from the generative AI model, extract parameters
representing at least time information, an apparatus category of a target device, an amount of change of a setting value, and an application condition, and map the parameters to the control commands.

### Supplementary 3

The system according to supplementary 1,
wherein the processor is configured to
cause the terminal device to display, in association with each other, the prompt sentence transmitted to the generative AI model, the response sentence corresponding to the prompt sentence, and the control commands generated from the response sentence, receive, from an operator via the terminal device, designation information for approving, rejecting, or changing each element of the control commands, determine control commands to be applied based on the designation information, and store the designation information as part of the stored information.

### Example 2

### Supplementary 1

A system comprising a processor,
wherein the processor is configured to
acquire observation information from a plurality of detection devices installed in an agricultural environment, the observation information including at least soil condition information, plant growth information, and environmental condition information, and to acquire external provision information including at least forecast information and demand information, and to generate agricultural work proposal information on the basis of the observation information, growth history information, and the external provision information, and to store the observation information, the growth history information, and the external provision information in a storage medium as accumulation information,
and wherein the processor is configured to
acquire operation history information of a terminal device operated by a user, and text information and voice information input by the user, to extract behavioral feature information and emotional feature information from the operation history information, the text information, and the voice information, and to calculate, by using a machine learning algorithm, an emotional state index including at least one of stress degree, fatigue degree, anxiety degree, and motivation degree,
and wherein the processor is configured to
determine, on the basis of the emotional state index, the observation information, the growth history information, and the external provision information, contents, an expression style, and a detail degree of a prompt sentence to be input to a generative AI model, and to generate the prompt sentence, to input the prompt sentence to the generative AI model, and to obtain, from the generative AI model, agricultural work proposal information in a natural language form, and wherein the processor is configured to
determine, on the basis of the emotional state index, a control policy including at least one of a presentation mode and a presentation frequency of the agricultural work proposal information for the user, and an automatic control range for agricultural machinery, and to
control, on the basis of the control policy, a mode of generation and transmission of control commands for the agricultural machinery,
and wherein the processor is configured to
generate, on the basis of the control policy and the agricultural work proposal information obtained from the generative AI model, control command information for agricultural machinery including at least one of an irrigation device, an application device, a spraying device, and a harvesting device, and to transmit the control command information to the agricultural machinery via a communication path,
and wherein the processor is configured to
control, on the basis of the control policy, a user interface of the terminal device such that a presentation mode and a presentation frequency of the agricultural work proposal information are adjusted in accordance with the emotional state index, and to cause the terminal device to present the agricultural work proposal information to the user and to acquire approval operation information or modification operation information from the user via the terminal device, and to update the control command information and the accumulation information on the basis of the approval operation information or the modification operation information.

### Supplementary 2

The system according to supplementary 1,
wherein the processor is configured to
aggregate, from the operation history information, at least an operation count, a cancellation operation count, and a screen residence time within a predetermined time window to generate the behavioral feature information, to convert the text information into vector data by using a natural language processing algorithm, to extract acoustic feature information from the voice information, to integrate the behavioral feature information, the vector data, and the acoustic feature information, and to calculate the emotional state index by inputting the integrated feature information to a deep learning model, and
wherein the processor is configured to
generate, when the emotional state index indicates a high-stress state or a high-anxiety state, a concise prompt sentence in which a number of proposal items is limited and use of technical terms is suppressed, and to generate, when the emotional state index indicates a high-motivation state, a detailed prompt sentence including a plurality of alternative strategies and detailed explanation of grounds.

### Supplementary 3

The system according to supplementary 1,
wherein the processor is configured to
analyze text included in the agricultural work proposal information output from the generative AI model, to extract numerical parameter information including at least one of an irrigation amount, an application amount, a spraying amount, an execution time, and a target area, to normalize the numerical parameter information into a safety range on the basis of the automatic control range included in the control policy, to transmit the control command information including the normalized numerical parameter information to the agricultural machinery immediately when the automatic control range indicates an automatic mode, and to cause the terminal device to present a control command candidate and to transmit the control command information to the agricultural machinery after acquisition of approval information from the user via the terminal device when the automatic control range indicates a semi-automatic mode.

### Application Example 2

### Supplementary 1

A system comprising a processor,
wherein the processor is configured to
acquire physical environment data from a plurality of detection devices arranged in an agricultural environment, the plurality of detection devices being configured to measure at least one of soil conditions, plant growth conditions, and surrounding environmental conditions,
receive, from an information processing terminal, evaluation information and natural language text information input by an operator or another stakeholder, apply at least one of a natural language processing model and another machine learning model to the evaluation information and the natural language text information, calculate an emotion index representing an emotional state of the operator or the other stakeholder, and aggregate the emotion index on an area basis and on a time basis,
associate and aggregate the physical environment data and the emotion index on the area basis and on the time basis, and calculate an integrated state that simultaneously represents a physical state and an emotional state in the agricultural environment,
generate, based on the integrated state, a prompt sentence to be input to a generative AI model, input the prompt sentence to the generative AI model, and acquire, from the generative AI model, an output including a control plan for at least one of an agricultural machine and an agricultural infrastructure and information providing content to be presented to the operator or the other stakeholder,
transmit, based on the control plan, a control command to at least one agricultural control device including at least one of an irrigation device, a chemical supplying device, a harvesting device, and an environmental control device, and operate the at least one agricultural control device in accordance with the control command,
transmit the information providing content to the information processing terminal and cause the information processing terminal to display or notify the information providing content, and
evaluate changes between the emotion index and the physical environment data acquired after execution of the control plan and the information providing content and the emotion index and the physical environment data acquired before the execution, and reflect an evaluation result in a next prompt sentence, thereby continuously improving, by the generative AI model, the control plan and the information providing content.

### Supplementary 2

The system according to supplementary 1,
wherein the processor is configured to
extract, from the integrated state, an area and a time period in which at least one physical index based on the physical environment data exceeds a predetermined threshold and at least one emotion index representing at least one of anger, dissatisfaction, and anxiety exceeds a predetermined threshold, and, for each extracted area and time period, automatically generate the prompt sentence including at least a specific numerical value of the physical environment data, a specific numerical value of the emotion index, a constraint related to control of the agricultural infrastructure, and a condition for not deteriorating the emotional state of the operator or the other stakeholder.

### Supplementary 3

The system according to supplementary 1,
wherein the processor is configured to
cause the information processing terminal to receive and display a message including at least one of guidance, warning, situation explanation, and presentation of an alternative related to at least one of the agricultural environment, a work load, and a control content executed by the system, and, after the operator or the other stakeholder has experienced the message and a change in the agricultural environment, acquire, via the information processing terminal, new evaluation information and new natural language text information from the operator or the other stakeholder and transmit the new evaluation information and the new natural language text information to the processor as new input to the emotion index calculation.

What is claimed is:

1. A server comprising:
circuitry configured to:
receive, via a communication interface coupled to a packet-switched network, observation information from a plurality of detection devices deployed in a spatial region;
aggregate the observation information and compute statistical information over predefined time windows, convert the statistical information into feature information formatted as numerical vectors, and input the feature information to a trained machine learning model to estimate at least one of a future state and a risk indicator for the spatial region;
convert a prediction result of the trained machine learning model and external information received via the communication interface into a natural language expression, generate a prompt sentence including the natural language expression, and input the prompt sentence to a transformer-based generative neural network model to obtain a response sentence describing an operation plan and a resource allocation policy;
parse the response sentence to extract control parameters comprising at least time information, apparatus category identifiers, setting values, and application conditions, and generate, based on the extracted control parameters, structured control commands for a plurality of actuators;
transmit the structured control commands via the communication interface to the plurality of actuators to change a physical state of the spatial region;
transmit display information comprising at least the observation information, the prediction result, the response sentence, and the operation plan to a terminal device via the communication interface;
receive, from the terminal device, intervention instruction information comprising at least one of an approval input, a modification input, and a cancellation input with respect to the operation plan; and
update the prompt sentence by incorporating preference information derived from the intervention instruction information and past intervention history as contextual information for subsequent input to the transformer-based generative neural network model.

2. The server according to claim 1, wherein the circuitry is further configured to:
store raw time-series records received from the plurality of detection devices in a time-series data store, each record indexed by a device identifier and a timestamp;
interpolate missing values in the raw time-series records; and
apply normalization to the interpolated values using precomputed scaling parameters to generate dimensionless feature values forming the feature information.

3. The server according to claim 2, wherein the circuitry is further configured to:
receive image data from at least one imaging device among the plurality of detection devices;
construct a tensor from the image data and input the tensor to a convolutional neural network model comprising convolution layers, batch normalization layers, and activation functions; and
obtain, from the convolutional neural network model, classification scores and category labels, and append the classification scores and the category labels to the feature information as additional vector components.

4. The server according to claim 3, wherein the trained machine learning model comprises a recurrent neural network including long short-term memory layers configured to model temporal dependencies in the feature information, the recurrent neural network receiving time-ordered sequences of the feature information and the external information and outputting predicted values for at least one target variable over a forecast horizon.

5. The server according to claim 4, wherein:
the plurality of detection devices comprise at least a soil moisture sensor, a pH sensor, a temperature sensor, and a crop imaging device installed in an agricultural facility;
the observation information comprises at least soil moisture data, soil pH data, ambient temperature data, and crop growth image data; and
the external information comprises at least weather forecast data and market demand data.

6. The server according to claim 5, wherein:
the plurality of actuators comprise at least an irrigation apparatus, a chemical spraying apparatus, and a harvesting apparatus deployed in the agricultural facility; and
the structured control commands comprise at least irrigation start times, irrigation durations, water volumes, chemical dosage quantities, spraying coordinates, and harvesting schedule parameters.

7. The server according to claim 1, wherein the circuitry is further configured to:
generate the prompt sentence by applying a template-based generation module that transforms numerical values from the prediction result into human-readable phrases using threshold-based descriptors and concatenates the phrases with descriptions of the external information and explicit optimization objectives into a single text string.

8. The server according to claim 7, wherein the circuitry is further configured to:
append, to the prompt sentence, statistical summaries derived from historical records stored in a database, the statistical summaries comprising at least yield trends, quality trends, and cost trends over a preceding period; and
append constraint conditions comprising at least resource usage limits and loss tolerance thresholds derived from the preference information.

9. The server according to claim 8, wherein the response sentence from the transformer-based generative neural network model describes a medium-to-long-term management plan spanning a plurality of weeks or months, the management plan comprising at least a planting schedule, input material quantities, labor allocation recommendations, and risk reduction measures.

10. The server according to claim 9, wherein the medium-to-long-term management plan comprises an agricultural management plan specifying at least seasonal planting varieties, fertilizer application schedules, pesticide usage budgets, irrigation water allocations, and projected harvest windows optimized based on predicted weather patterns and market price forecasts.

11. The server according to claim 1, wherein the circuitry is further configured to:
parse the response sentence by applying at least one of rule-based text parsing, pattern matching, and an auxiliary language model configured for information extraction;
identify phrases in the response sentence corresponding to numeric quantities and time expressions; and
convert the identified phrases into structured data fields comprising at least start time, end time, duration, target area identifier, and operational parameter values.

12. The server according to claim 11, wherein the circuitry is further configured to:
format each structured data field into a device-specific command message comprising a command type, a target device identifier, and the operational parameter values; and
transmit each device-specific command message to a respective actuator controller via a communication protocol supported by the actuator controller.

13. The server according to claim 12, wherein the circuitry is further configured to:
receive, from each actuator, execution result data comprising at least execution status, resource consumption values, and measured effect values;
store the execution result data in association with the corresponding structured control commands and the observation information in a database; and
update training data for the trained machine learning model based on the execution result data and the intervention instruction information to improve subsequent prediction accuracy.

14. The server according to claim 1, wherein the circuitry is further configured to:
transmit, to the terminal device, a graphical representation of the operation plan comprising at least a timeline of scheduled operations and parameter summaries for each scheduled operation;
receive, from the terminal device, a modification input specifying at least one of a parameter adjustment and a schedule change for a selected operation; and
regenerate the structured control commands for the selected operation based on the modification input without regenerating the entire operation plan.

15. The server according to claim 14, wherein the circuitry is further configured to:
receive, from the terminal device, a user-authored prompt sentence;
append contextual data comprising current observation information and the prediction result to the user-authored prompt sentence; and
input the appended prompt sentence to the transformer-based generative neural network model to obtain a supplementary response sentence, and transmit the supplementary response sentence to the terminal device.

16. The server according to claim 1, wherein the circuitry is further configured to:
acquire, via the communication interface, behavioral data, text data, and voice data from the terminal device;
extract behavioral feature information from the behavioral data, convert the text data into vector data by applying a natural language processing model, and extract acoustic feature information from the voice data; and
integrate the behavioral feature information, the vector data, and the acoustic feature information and input integrated feature data to a deep learning model to compute an emotional state index comprising at least one of a stress degree, a fatigue degree, an anxiety degree, and a motivation degree.

17. The server according to claim 16, wherein the circuitry is further configured to:
generate, when the emotional state index indicates a high-stress state or a high-anxiety state, a concise prompt sentence in which a number of proposal items is limited; and
generate, when the emotional state index indicates a high-motivation state, a detailed prompt sentence including a plurality of alternative strategies and detailed explanations.

18. A server comprising:
circuitry configured to:
receive, via a communication interface coupled to a packet-switched network, observation information from a plurality of detection devices deployed in a spatial region, store raw time-series records in a time-series data store indexed by device identifier and timestamp, interpolate missing values, and apply normalization using precomputed scaling parameters to generate feature information formatted as numerical vectors;
input image data received from at least one imaging device among the plurality of detection devices to a convolutional neural network model to obtain classification scores and category labels, and append the classification scores and the category labels to the feature information;
input the feature information and external information received via the communication interface to a recurrent neural network model including long short-term memory layers to estimate at least one of a future state and a risk indicator for the spatial region;
convert a prediction result and the external information into a natural language expression, generate a prompt sentence by applying a template-based generation module that transforms numerical values into human-readable phrases and appends optimization objectives, constraint conditions derived from user preference information, and statistical summaries from historical records, and input the prompt sentence to a transformer-based generative neural network model to obtain a response sentence describing an operation plan;
parse the response sentence by applying at least one of rule-based text parsing and pattern matching to extract control parameters comprising time information, apparatus category identifiers, setting values, and application conditions, and format the extracted control parameters into device-specific command messages;
transmit the device-specific command messages via the communication interface to a plurality of actuators to change a physical state of the spatial region, and receive execution result data from the plurality of actuators;
transmit display information comprising the observation information, the prediction result, the response sentence, and the operation plan to a terminal device via the communication interface, receive intervention instruction information comprising at least one of an approval input, a modification input, and a cancellation input, and regenerate structured control commands based on the intervention instruction information; and
store the execution result data, the intervention instruction information, and the observation information in a database, and update training data for the recurrent neural network model and generation rules for the prompt sentence based on the stored information.

19. The server according to claim 18, wherein:
the plurality of detection devices comprise at least a soil moisture sensor, a pH sensor, a temperature sensor, and a crop imaging device installed in an agricultural facility;
the plurality of actuators comprise at least an irrigation apparatus, a chemical spraying apparatus, and a harvesting apparatus; and
the prompt sentence further includes constraint conditions indicating at least one of an allowable chemical use amount and a water use limitation amount derived from the user preference information.

20. A method performed by a server comprising circuitry, the method comprising:
receiving, via a communication interface coupled to a packet-switched network, observation information from a plurality of detection devices deployed in a spatial region;
aggregating the observation information and computing statistical information over predefined time windows, converting the statistical information into feature information formatted as numerical vectors, and inputting the feature information to a trained machine learning model to estimate at least one of a future state and a risk indicator for the spatial region;
converting a prediction result of the trained machine learning model and external information received via the communication interface into a natural language expression, generating a prompt sentence including the natural language expression, and inputting the prompt sentence to a transformer-based generative neural network model to obtain a response sentence describing an operation plan and a resource allocation policy;
parsing the response sentence to extract control parameters comprising at least time information, apparatus category identifiers, setting values, and application conditions, and generating, based on the extracted control parameters, structured control commands for a plurality of actuators;
transmitting the structured control commands via the communication interface to the plurality of actuators to change a physical state of the spatial region;
transmitting display information comprising at least the observation information, the prediction result, the response sentence, and the operation plan to a terminal device via the communication interface;
receiving, from the terminal device, intervention instruction information comprising at least one of an approval input, a modification input, and a cancellation input with respect to the operation plan; and
updating the prompt sentence by incorporating preference information derived from the intervention instruction information and past intervention history as contextual information for subsequent input to the transformer-based generative neural network model.
